(19) United States
(12) Patent Application Publication
(10) Pub. No.: US 2026/0214360 A1
(43) Pub. Date: Jul. 23, 2026

(54) IMAGE SENSOR AND OPERATION METHOD THEREOF

(71) Applicant: Samsung Electronics Co., Ltd., Suwon-si (KR)

(72) Inventors: Daeyun KIM, Suwon-si (KR); Kyung-Min KIM, Suwon-si (KR)

(73) Assignee: Samsung Electronics Co., Ltd., Suwon-si (KR)

(21) Appl. No.: 19/288,363

(22) Filed: Aug. 1, 2025

(30) Foreign Application Priority Data
Jan. 21, 2025 (KR) 10-2025-0008818

(51) Int. Cl. H04N 25/78; H04N 25/51; H04N 25/60; H04N 25/77

(52) U.S. Cl. CPC H04N 25/78; H04N 25/51; H04N 25/77; H04N 25/60

(57) ABSTRACT

An image sensor includes a first pixel configured to output a first pixel signal corresponding to a first conversion gain, a second pixel signal corresponding to a second conversion gain, a third pixel signal corresponding to the second conversion gain, and a fourth pixel signal corresponding to the first conversion gain, through a first column line, a ramp signal generator configured to sequentially output a first ramp signal corresponding to a first analog gain, a second ramp signal corresponding to a second analog gain, a third ramp signal corresponding to the second analog gain, and a fourth ramp signal corresponding to the first analog gain, and an analog-to-digital converter configured to performs an auto-zero operation based on any one of the first reset level and the second reset level, perform analog-to-digital conversion; the auto-zero operation for the analog-to-digital conversion based on the first to fourth pixel signals is performed once.

### CROSS-REFERENCE TO RELATED APPLICATIONS

This application claims priority under 35 U.S.C. § 119 to Korean Patent Application No. 10-2025-0008818 filed on Jan. 21, 2025, in the Korean Intellectual Property Office, the disclosures of which are incorporated by reference herein in their entireties.

### BACKGROUND

Some example embodiments described herein relate to an image sensor, and more particularly, relate to an image sensor and/or an operation method of the image sensor.

An image sensor obtains image information about an external object by converting a light reflected from the external object into an electrical signal. An electronic device which includes the image sensor may display an image in a display panel by using the obtained image information.

The image sensor may obtain the image information by adopting a correlated double sampling (CDS) manner. In this case, the image sensor may remove or reduce the noise of the image information. To implement the high dynamic range (HDR), the image sensor may perform a readout operation through a dual conversion gain (DCG) mode to obtain the image information. Meanwhile, there is expected an image sensor which performs the readout operation through the DCG mode, has a small area, and provides excellent noise removal performance.

### SUMMARY

Some example embodiments may provide an image sensor with improved performance and an operation method of the imaging sensor.

According to some example embodiments embodiment, an image sensor includes a first pixel configured to sequentially output a first pixel signal having a first reset level corresponding to a first conversion gain, a second pixel signal having a second reset level corresponding to a second conversion gain different from the first conversion gain, a third pixel signal having a second signal level corresponding to the second conversion gain, and a fourth pixel signal having a first signal level corresponding to the first conversion gain. The first pixel is configured to output through a first column line. The image sensor further includes a ramp signal generator configured to sequentially output a first ramp signal corresponding to a first analog gain, a second ramp signal corresponding to a second analog gain different from the first analog gain, a third ramp signal corresponding to the second analog gain, and a fourth ramp signal corresponding to the first analog gain. The image sensor further includes an analog-to-digital converter connected to the first column line, is configured to perform an auto-zero operation based on any one or more of the first reset level and the second reset level, to perform analog-to-digital conversion by comparing the first reset level and the first ramp signal, to compare the second reset level and the second ramp signal, to compare the second signal level and the third ramp signal, and to compare the first signal level and the fourth ramp signal, and to perform the auto-zero operation for the analog-to-digital conversion based on the first to fourth pixel signals only once.

Alternatively or additionally according to some example embodiments, an operation method of an image sensor which includes a first pixel configured to sequentially output a first pixel signal having a first reset level corresponding to a first conversion gain, a second pixel signal having a second reset level corresponding to a second conversion gain, a third pixel signal having a second signal level corresponding to the second conversion gain, and a fourth pixel signal having a first signal level corresponding to the first conversion gain, the sequential output through a first column line. The method includes performing a reset operation on the first pixel, performing an auto-zero operation based on the second reset level, performing a first reset sampling operation of comparing the first reset level and a first ramp signal corresponding to a first analog gain, performing a second reset sampling operation of comparing the second reset level and a second ramp signal corresponding to a second analog gain, performing a first signal sampling operation of comparing the second signal level and a third ramp signal corresponding to the second analog gain, and performing a second signal sampling operation of comparing the first signal level and a fourth ramp signal corresponding to the first analog gain. The first column line is connected to one analog-to-digital converter, and the second conversion gain is greater the first analog gain.

Alternatively or additionally according to some example embodiments, an image sensor includes a first pixel configured to sequentially output a first pixel signal having a first reset level corresponding to a first conversion gain, a second pixel signal having a second reset level corresponding to a second conversion gain different from the first conversion gain, a third pixel signal having a second signal level corresponding to the second conversion gain, and a fourth pixel signal having a first signal level corresponding to the first conversion gain. The image sensor is configured to output the first through fourth pixel signal through a first column line. The image sensor further includes a ramp signal generator configured to sequentially output a first ramp signal corresponding to a first analog gain, a second ramp signal corresponding to a second analog gain smaller than the first analog gain, a third ramp signal corresponding to the second analog gain, and a fourth ramp signal corresponding to the first analog gain. The image sensor further includes an analog-to-digital converter connected to the first column line, is configured to perform an auto-zero operation based on the first reset level, and to perform analog-to-digital conversion by comparing the first reset level and the first ramp signal, comparing the second reset level and the second ramp signal, comparing the second signal level and the third ramp signal, and comparing the first signal level and the fourth ramp signal. The first ramp signal and the fourth ramp signal correspond to a first offset, the second ramp signal and the third ramp signal correspond to a second offset, and the second offset has a negative value.

Alternatively or additionally according to some example embodiments, there is provided a multi-camera module comprising an application processor, and a plurality of camera modules connected to the application processor. At least one of the plurality of camera modules includes a pixel comprising a photoelectric conversion element configured to accumulate charges in response to a light signal received from the outside, a transfer transistor connected between the photoelectric conversion element and a floating diffusion node, a reset transistor configured to provide a reset voltage to the floating diffusion node, a dual conversion gain transistor connected between the floating diffusion node and the reset transistor, a source follower transistor configured to generate a pixel signal corresponding to a voltage of the floating diffusion node, and a selection transistor connected to the source follower transistor, and configured to output the pixel signal to the first column line. The pixel is configured to operate for a first timeframe wherein the selection transistor is off, the reset transistor is on, the dual conversion gain transistor is on, and the transfer transistor is off. The pixel is configured to operate for a second timeframe after the first timeframe where the reset transistor is off. The pixel is configured to operate in a third timeframe after the second timeframe where the dual conversion gain transistor is off. The pixel is configured to operate in a fourth timeframe after the third timeframe where the dual conversion is off. The pixel is configured to operate in a fifth timeframe after the fourth timeframe where the transfer transistor is on. The pixel is configured to operate in sixth time frame after the fifth timeframe where the transfer transistor is off. The pixel is configured to operate in a seventh timeframe after the sixth timeframe where the dual conversion gain transistor is on. The pixel is configured to operate in an eighth timeframe after the seventh timeframe where the transfer transistor is on. The pixel is configured to operate in a ninth timeframe after the eighth timeframe where the transfer transistor is off.

In some example embodiments, one of the camera modules is a vertical shape of depth camera configured to extract depth information based on an infrared ray.

In some example embodiments, at least two of the camera modules among the plurality of camera modules have a different field of view.

In some example embodiments, the plurality of camera modules are physically separate from each other.

In some example embodiments, the application processor includes an image processing device configured to process an image captured by at least one of the plurality of camera modules.

In some example embodiments, the image processing device is configured to generate at least a portion of a first image data generated from a first one of the plurality of camera modules with at least a portion of second image data generated from a second one of the plurality of camera modules.

### BRIEF DESCRIPTION OF THE FIGURES

The above and other objects and features of various inventive concepts will become apparent by describing in detail embodiments thereof with reference to the accompanying drawings.

FIG. 1 is a block diagram illustrating an image sensor according to some example embodiments.

FIG. 2 is an example of a circuit diagram illustrating a pixel of FIG. 1.

FIG. 3A is a diagram for describing an example of an ADC included in an ADC circuit of FIG. 1.

FIG. 3B is an example of a circuit diagram illustrating a comparator of FIG. 3A.

FIG. 4 is a timing diagram for describing an example of an operation of an image sensor of FIG. 1.

FIGS. 5A and 5B are diagrams for describing another example of an operation of an image sensor of FIG. 1.

FIG. 6 is a timing diagram for describing an operation of an image sensor of FIG. 1 according to some example embodiments.

FIG. 7 is a block diagram illustrating a ramp signal generator of FIG. 1.

FIG. 8 is a circuit diagram for describing an example of a signal generator of FIG. 7.

FIG. 9 is a diagram for describing an example of a ramp signal generated by a ramp signal generator of FIG. 7.

FIG. 10 is a timing diagram for describing another example of an operation of an image sensor of FIG. 1 according to some example embodiments.

FIG. 11 is a timing diagram for describing another example of an operation of an image sensor of FIG. 1 according to some example embodiments.

FIG. 12 is a flowchart for describing an operation method of an image sensor according to some example embodiments.

FIG. 13 is a block diagram of an electronic device including a multi-camera module.

FIG. 14 is a block diagram illustrating a camera module of FIG. 13 in detail.

### DETAILED DESCRIPTION

Below, some example embodiments will be described in detail and clearly to such an extent that an ordinary one in the art easily carries out the present disclosure.

In the specification, function blocks of drawings, which respectively correspond to the terms “block”, “unit”, “logic”, etc., may be implemented in the form of software, hardware, or a combination thereof.

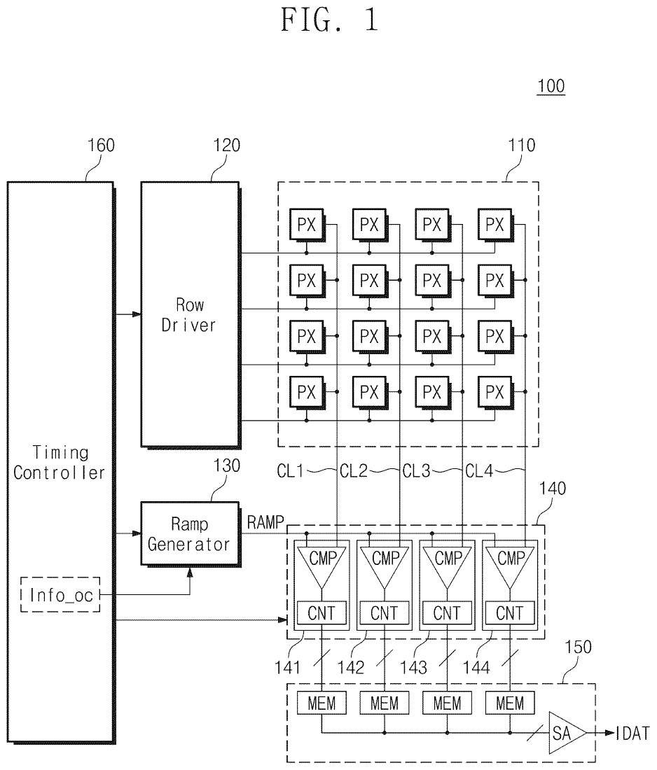

FIG. 1 is a block diagram illustrating an image sensor according to some example embodiments. Referring to FIG. 1, an image sensor 100 may include a pixel array 110, a row driver 120, a ramp signal generator 130, an analog-to-digital converter (ADC) circuit 140, a buffer 150, and a timing controller 160.

The pixel array 110 may include a plurality of pixels PX arranged in rows and columns in the form of a matrix. A number of rows may be the same as, or different from (e.g., greater than or less than) a number of columns. The pixel array 110 may be divided into, e.g., partitioned into, a number of blocks or sub-arrays; example embodiments are not limited thereto. Each of the plurality of pixels PX may include a photoelectric conversion element. For example, the photoelectric conversion element may include a photodiode, a photo transistor, a photo gate, or a pinned photodiode. Each of the plurality of pixels PX may sense a light by using the photoelectric conversion element and may convert the sensed light into an electrical signal (hereinafter referred to as a “pixel signal”). An example in which the pixel array 110 includes the pixels PX arranged in the form of a matrix with four rows and four columns is illustrated in FIG. 1, but example embodiments are not limited thereto.

In some example embodiments, all of, or at least some of, the pixels PX may support a dual conversion gain (DCG) mode. Accordingly, the pixel PXs may operate in a low conversion gain (LCG) mode and a high conversion gain (HCG) mode.

The plurality of pixels PX may generate pixel signals in response to various control signals (e.g., a transfer signal VTG, a reset signal VRST, and a selection signal VSEL) received from the row driver 120 and may output the pixel signals through a plurality of column lines CL1 to CL4.

The row driver 120 may select and drive a row of the pixel array 110. The row driver 120 may decode an address and/or a control signal generated by the timing controller 160 and may generate control signals (e.g., one or more of VRST, VDC, VTG, and VSEL) for selecting and driving a row of the pixel array 110.

The ramp signal generator 130 may generate a ramp signal RAMP. The ramp signal generator 130 may operate under control of the timing controller 160. For example, the ramp signal generator 130 may operate in response to control signals such as a ramp enable signal and a mode signal. When the ramp enable signal is activated, the ramp signal generator 130 may generate the ramp signal RAMP with a slope, such as a dynamically determined (or, alternatively, preset) slope. In some example embodiments, the ramp signal generator 130 may receive compensation offset information info_oc from the timing controller 160. The ramp signal generator 130 may adjust an offset voltage of the ramp signal RAMP based on the compensation offset information info_oc.

The ADC circuit 140 may perform analog-to-digital conversion such that an analog signal (e.g., the pixel signal) output from the pixel array 110 is converted into a digital signal. The ADC circuit 140 may include, for example, less than four, more than four, or ADC's, such as four ADCs 141 to 144, each of which may include a comparator CMP and a counter CNT. The comparator CMP may compare the pixel signal output through a column line (e.g., one of CL1 to CL4) connected to the comparator CMP with the ramp signal RAMP and may output a comparison result. For example, the comparator CMP may operate based on a correlated double sampling (CDS) technique; example embodiments are not limited thereto.

For example, pixel signals output from a plurality of pixels may have a deviation due to an inherent characteristic (e.g., a fixed pattern noise (FPN)) of each pixel and/or a deviation due to a characteristic difference of logic for outputting the pixel signals. To compensate for or at least partially compensate for the deviation between the pixel signals, an operation of obtaining a reset level and a signal level for each pixel signal and extracting a difference between the reset level and the signal level as an effective signal component may be referred to as “correlated double sampling”.

For example, the ADC 141 may perform analog-to-digital conversion by comparing a pixel signal having an HCG-reset level, a pixel signal having an LCG-reset level, a pixel signal having an LCG-signal level, and a pixel signal having an HCG-signal level, which are output from the first column line CL1, with the ramp signal RAMP.

The counter CNT may count an output signal of the corresponding comparator CMP. The counter CNT may operate under control of the timing controller 160. For example, the counter CNT may operate in response to control signals such as one or more of a counter clock signal, a counter reset signal for controlling the reset of the counter CNT, and an inversion signal for inverting an internal bit of the counter CNT. The counter CNT may count a comparison result signal depending on the counter clock signal so as to be output as a digital signal.

For example, the counter CNT may include one or more of an up/down counter, a bit-wise inversion counter, etc. An operation of the bit-wise inversion counter may be similar to an operation of the up/down counter. For example, the bit-wise inversion counter may perform a function of only performing up-counting and a function of converting all internal bits of a counter to obtain the 1's-complement when a specific signal is input thereto. The bit-wise inversion counter may perform a reset count operation so as to be converted into the 1's-complement, that is, to a negative value.

The timing controller 160 may generate a control signal and/or a clock for controlling an operation and/or a timing of each of the row driver 120, the ramp signal generator 130, and the ADC circuit 140.

The buffer 150 may include plurality of memories MEM and a sense amplifier SA. The plurality of memories MEM may store digital signals output from the corresponding ADCs 141 to 144. The sense amplifier SA may sense and amplify, e.g., may amplify a voltage difference of the digital signals stored in the memories MEM. The sense amplifier SA may output the amplified digital signals as image data IDAT.

For example, the image sensor 100 may perform the readout operation on the pixel PX based on a reset-sig-sig-reset (RSSR) manner. In this case, the image sensor 100 may sequentially perform an HCG-reset sampling operation, an HCG-signal sampling operation, an LCG-signal sampling operation, and an LCG-reset sampling operation. In this case, after the LCG-signal sampling operation is performed, the reset operation may be performed, and the LCG-reset sampling operation may then be performed. A counting value corresponding to the sampled LCG-signal level may include a first noise component due to the reset operation performed before the HCG-reset sampling operation. A counting value corresponding to the sampled LCG-reset level may include a second noise component due to the reset operation performed after the LCG-signal sampling operation. Accordingly, the image sensor 100 may fail to perform complete sampling on LCG levels.

According to some example embodiments, the image sensor 100 may adjust an offset of the ramp signal RAMP and may perform the readout operation on the pixel PX based on a reset-reset-sig-sig (RRSS) manner. The image sensor 100 may sequentially perform the LCG-reset sampling operation, the HCG-reset sampling operation, the HCG-signal sampling operation, and the LCG-signal sampling operation. For example, the image sensor 100 may not perform a separate reset operation after the LCG-reset sampling operation. According to the above description, the noise which is caused in association with the LCG levels (e.g., the LCG-reset level and the LCG-signal level) when the image sensor 100 operates in the RSSR manner may be partially or fully removed (e.g., the complete sampling may be performed). Alternatively or additionally, the image sensor 100 may be configured to have the same area as an image sensor operating based on the RSSR manner but may operate based on the RRSS manner. Accordingly, according to some example embodiments, an image sensor capable of improving noise removal performance without the increase in the area and/or an operation method thereof may be performed.

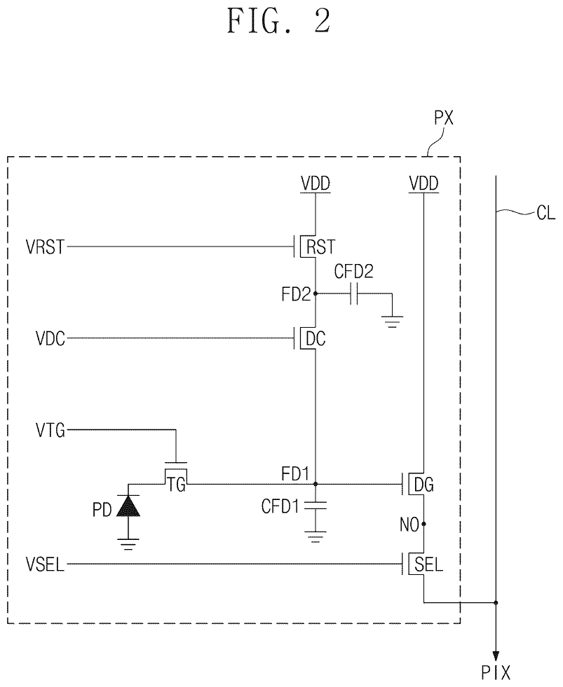

FIG. 2 is an example of a circuit diagram illustrating a pixel of FIG. 1. Referring to FIGS. 1 and 2, the pixel PX may include a photoelectric conversion element PD, a transfer transistor TG, a dual conversion gain transistor DC, a reset transistor RST, a source follower transistor DG, and a selection transistor SEL. Each of the transfer transistor TG, the dual conversion gain transistor DC, the reset transistor RST, the source follower transistor DG, and the selection transistor SEL may be NMOS transistors; however, example embodiments are not limited thereto. The photoelectric conversion element PD may be configured to generate charges corresponding to the intensity of light incident from the outside.

When the dual conversion gain transistor DC is turned off, a first floating diffusion node FD1 may be only connected to a first floating diffusion capacitor CFD1. When the dual conversion gain transistor DC is turned on, the first floating diffusion node FD1 may be electrically connected to a second floating diffusion node FD2. According to the above description, the capacitance of the floating diffusion nodes FD1 and FD2 may be expanded to a sum of a capacitance of the first floating diffusion capacitor CFD1 and a capacitance of a second floating diffusion capacitor CFD2; for example, the first floating diffusion capacitor CFD1 and the second floating diffusion capacitor CFD2 may be in series when the dual conversion gain transistor DC is turned on. Below, the first floating diffusion node FD1 and the second floating diffusion node FD2 electrically connected by the turned-on dual conversion gain transistor DC is referred to as an “expanded floating diffusion node”. For example, the floating diffusion capacitors CFD1 and CFD2 may be a parasitic capacitor and/or a capacitor element.

The transfer transistor TG may transfer the charges (e.g., electrons and/or holes) generated by the photoelectric conversion element PD to the first floating diffusion node FD1 or the expanded floating diffusion node. For example, a first end of the transfer transistor TG may be connected to the photoelectric conversion element PD, and a second end thereof may be connected to the first floating diffusion node FD1. The transfer transistor TG may be controlled by the transfer signal VTG received from the row driver 120.

The first floating diffusion node FD1 or the expanded floating diffusion node (e.g., including the first floating diffusion node FD1 and the second floating diffusion node FD2) may accumulate charges corresponding to the amount of incident light. The first floating diffusion node FD1 may have a capacitance corresponding to the first floating diffusion capacitor CFD1. During a time during which the transfer transistor TG is turned on by the transfer signal VTG, the charges provided from the photoelectric conversion element PD may be accumulated in the first floating diffusion node FD1 or the expanded floating diffusion node. The first floating diffusion node FD1 may be connected to a gate terminal of the source follower transistor DG which operates as a source follower amplifier. According to the above description, a voltage potential corresponding to the charges accumulated in the first floating diffusion node FD1 may be formed.

Meanwhile, when the intensity of light is strong, the capacitance of the first floating diffusion node FD1 may not be enough to contain the charges generated by the photoelectric conversion element PD. In this case, because the first floating diffusion node FD1 is more likely to be easily saturated, information of an image to be photographed (or captured) may not be properly generated. Accordingly, the second floating diffusion capacitor CFD2 may be used to prevent or reduce the likelihood of and/or impact from the saturation. The second floating diffusion capacitor CFD2 may be provided between the reset transistor RST and the dual conversion gain transistor DC. When the dual conversion gain transistor DC is turned on, the first floating diffusion node FD1 and the second floating diffusion node FD2 may be connected. According to the above description, the capacitance of the pixel PX may be increased to a sum of the capacitance of the first floating diffusion capacitor CFD1 and the capacitance of the second floating diffusion capacitor CFD2.

When the dual conversion gain transistor DC is turned off, the pixel PX may be referred to as “operating in the HCG mode”. When the dual conversion gain transistor DC is turned on, the pixel PX may be referred to as “operating in the LCG mode”.

The reset transistor RST may be turned on based on the reset signal VRST, and thus, a reset voltage (e.g., a pixel power supply voltage VDD) may be provided to the first floating diffusion node FD1 or the expanded floating diffusion node. In this case, the charges accumulated in the first floating diffusion node FD1 or the expanded floating diffusion node may move to a terminal for the pixel power supply voltage VDD, for example, a voltage of the first floating diffusion node FD1 or the expanded floating diffusion node may be reset. For example, an operation of turning on the reset transistor RST such that the voltage of the first floating diffusion node FD1 or the expanded floating diffusion node is reset may be referred to as a “reset operation”.

The source follower transistor DG may amplify a change in an electrical potential of the first floating diffusion node FD1 or the expanded floating diffusion node (e.g., including the first floating diffusion node FD1 and the second floating diffusion node FD2) and may generate a voltage (e.g., a pixel signal PIX) corresponding to the amplified result. The selection transistor SEL may be driven by the selection signal VSEL and may select pixels to be read in units of row. When the selection transistor SEL is turned on, the selection transistor SEL may output the pixel signal PIX to the column line CL.

For example, after the reset operation is performed, a voltage level of the pixel signal PIX output by the pixel PX in the LCG mode may be referred to as an “LCG-reset level”. For example, after the reset operation is performed, a voltage level of the pixel signal PIX output by the pixel PX in the HCG mode may be referred to as an “HCG-reset level”. For example, after the reset operation, in the LCG mode, a voltage level of the pixel signal PIX corresponding to the charges accumulated in the expanded floating diffusion node after provided from the photoelectric conversion element PD may be referred to as an “LCG-signal level”. For example, after the reset operation, in the HCG mode, a voltage level of the pixel signal PIX corresponding to the charges accumulated in the first floating diffusion node FD1 after provided from the photoelectric conversion element PD may be referred to as an “HCG-signal level”.

The pixel structure described with reference to FIG. 2 is provided as an example, and the scope of example embodiments are not limited thereto. For example, the pixel may be implemented based on various pixel structures such as a split photodiode structure, a 4-photodiode structure, and a shared pixel structure.

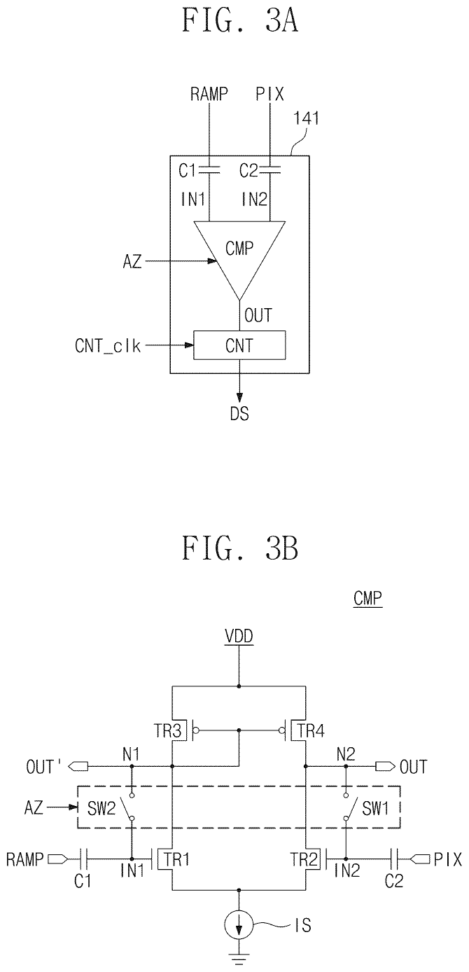

FIG. 3A is a diagram for describing an example of an ADC included in an ADC circuit of FIG. 1. FIG. 3B is an example of a circuit diagram illustrating a comparator of FIG. 3A. Referring to FIG. 3A, the ADC 141 may include a first capacitor C1, a second capacitor C2, the comparator CMP, and the counter CNT.

The comparator CMP may receive the ramp signal RAMP transmitted from the ramp signal generator 130 through the first capacitor C1. The ramp signal RAMP may be input to the comparator CMP as a first input IN1. The first input IN1 may be input to a first input terminal of the comparator CMP. The comparator CMP may receive the pixel signal PIX transmitted from the first column line CL1 through the second capacitor C2. The pixel signal PIX may be input to the comparator CMP as a second input IN2. The second input IN2 may be input to a second input terminal of the comparator CMP. Herein, the pixel signal PIX may be or may correspond to a signal output from the pixel PX connected to the first column line CL1. The comparator CMP may compare the ramp signal RAMP and the pixel signal PIX and may output a comparison result OUT. The comparator CMP may be implemented as and/or embodied as an operational amplifier and/or as a dedicated comparator; however, example embodiments are not limited thereto.

The comparison result OUT may be provided to the counter CNT. Before the ramp signal RAMP and the pixel signal PIX are compared, for example, before a comparison operation is performed, the comparator CMP may perform an auto-zero operation in response to an auto zero signal AZ. Voltages of the first input IN1 and the second input IN2 may be adjusted to an auto-zero voltage through the auto-zero operation. As the auto-zero operation is performed, a voltage corresponding to a difference between an initial voltage of the ramp signal RAMP and the auto-zero voltage may be stored in the first capacitor C1. Also, a voltage corresponding to a difference between an initial voltage of the pixel signal PIX and the auto-zero voltage may be stored in the second capacitor C2. Meanwhile, offset cancellation of the comparator CMP may be performed by the auto-zero operation.

The counter CNT may count the comparison result OUT received from the comparator CMP based on a counting clock CNT_CLK and may generate a digital signal DS. For example, the digital signal DS may have a digital value (e.g., a binary value) corresponding to a difference between a signal level and a reset level of the pixel signal PIX. The digital signal DS may correspond to the LCG-signal or the HCG-signal.

Referring to FIG. 3B, in some example embodiments the comparator CMP may include first to fourth transistors TR1 to TR4, first and second switches SW1 and SW2 that may or may not be transistors, the first and second capacitors C1 and C2, and a current source IS. The first transistor TR1 may receive the ramp signal RAMP as the first input IN1 through the first capacitor C1. The second transistor TR2 may receive the pixel signal PIX as the second input IN2 through the second capacitor C2. In some example embodiments, each of the transistors TR1 and TR2 may be an NMOS transistor. The transistors TR1 and TR2 may generate a current according to a level difference of the first input IN1 and the second input IN2. When the level of the first input IN1 is the same as the level of the second input IN2, the same current may flow through the transistors TR1 and TR2. In contrast, when the level of the first input IN1 is different from the level of the second input IN2, currents of different levels may flow through the transistors TR1 and TR2.

The transistors TR3 and TR4 may generate comparison results OUT′ and OUT′ whose voltage levels are determined depending on current mirroring. Each of the transistors TR3 and TR4 may be a PMOS transistor. When the voltage level of the first input IN1 is higher than the voltage level of the second input IN2, a current whose amount is relatively large may flow through the first transistor TR1. Accordingly, a voltage level of a first node N1 may decrease, and a voltage level of a second node N2 may increase. In this case, the comparison result OUT may have the high level. For example, the comparison result OUT may have the high level in a time period where the level of the ramp signal RAMP is higher than the level of the pixel signal PIX and may have the low level in a time period where the level of the ramp signal RAMP is lower than the level of the pixel signal PIX.

Meanwhile, the switches SW1 and SW2 may be turned on in response to the auto zero signal AZ. As the switches SW1 and SW2 are turned on, the comparator CMP may perform the auto-zero operation. When the switches SW1 and SW2 are turned on, the first input IN1 and the first node (e.g., a first output node) N1 may be connected to each other, and the second input IN2 and the second node (e.g., a second output node) N2 may be connected to each other. Accordingly, the first input IN1, the second input IN2, the first node N1, and the second node N2 may have the same level. The levels of the first input IN1, the second input IN2, the first node N1, and the second node N2 set by the auto-zero operation may be referred to as an “auto-zero voltage”. Meanwhile, for example, after the auto-zero operation is performed, the charges corresponding to a difference between the initial voltage of the ramp signal RAMP and the auto-zero voltage may be stored in the first capacitor C1, and the charges corresponding to a difference between the initial voltage of the pixel signal PIX and the auto-zero voltage may be stored in the second capacitor C2.

FIG. 3B is a circuit diagram illustrating one example of the comparator CMP, and the comparator CMP may be implemented in various structures. For example, the comparator CMP ma further include an inverting amplifier which receives the comparison result OUT as an input and outputs an inverted signal of the comparison result OUT to the counter CNT.

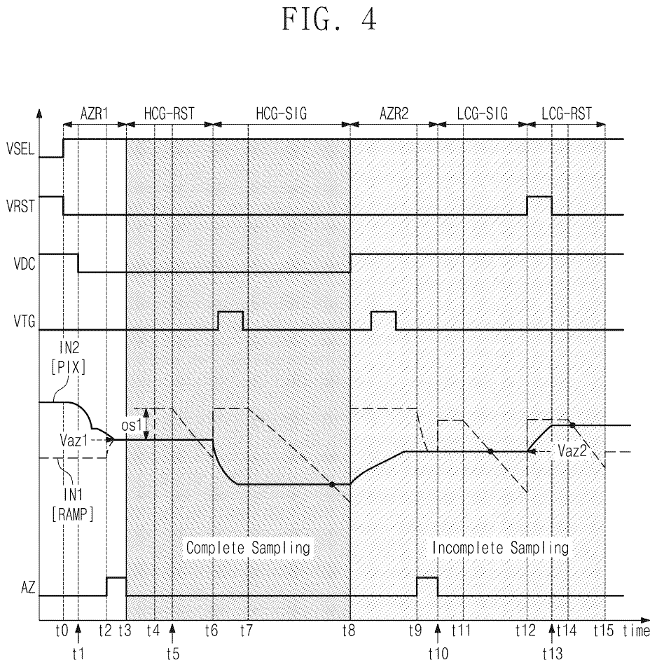

FIG. 4 is a timing diagram for describing an example of an operation of an image sensor of FIG. 1. Referring to FIGS. 1 and 4, the image sensor 100 may perform the readout operation based on the RSSR manner.

Before a 0-th time point t0, the reset transistor RST and the dual conversion gain transistor DC may be turned on in response to the reset signal VRST of logic high and a dual conversion signal VDC of logic high, and the transfer transistor TG and the selection transistor SEL may be turned off in response to the transfer signal VTG of logic low and the selection signal VSEL of logic low. In this case, the image sensor 100 may perform the reset operation on the pixel PX.

At the 0-th time point t0, the selection transistor SEL may be turned on in response to the selection signal VSEL of logic high. In this case, the pixel PX may output the pixel signal PIX having the LCG-reset level.

In a first auto-zero period AZR1 from t0 to t3, the image sensor 100 may perform a first auto-zero operation. At the first time point t1, the dual conversion gain transistor DC may be turned off in response to the dual conversion signal VDC of logic low. In this case, the pixel signal PIX may have the HCG-reset level. During a time period from t2 to t3, the comparator CMP may perform the first auto-zero operation, based on the auto zero signal AZ of logic high. Accordingly, a voltage level of the first input IN1 corresponding to the ramp signal RAMP and a voltage level of the second input IN2 corresponding to the pixel signal PIX may be adjusted to a first auto-zero voltage Vaz1. For example, the comparator CMP may perform the first auto-zero operation based on the pixel signal PIX having the HCG-reset level. Accordingly, the first auto-zero voltage Vaz1 may be determined based on the pixel signal PIX having the HCG-reset level and the voltage level of the ramp signal RAMP.

In an HCG-reset sampling period HCG-RST from t3 to t6, the image sensor 100 may sample a reset level in the HCG mode. At the fourth time point t4, a first offset os1 may be applied to the ramp signal RAMP. During a time period from t5 to t6, the voltage level of the ramp signal RAMP may decrease. The counter CNT may count a time point at which the voltage level of the first input IN1 is the same as the voltage level of the second input IN2. A counting value may correspond to the HCG-reset level.

In an HCG-signal sampling period HCG-SIG from t6 to t8, the image sensor 100 may sample a signal level in the HCG mode. During a time period from t6 to t7, the transfer transistor TG may be turned on in response to the transfer signal VTG of logic high, and thus, the charges generated by the photoelectric conversion element PD may move to the first floating diffusion node FD1. Accordingly, the voltage level of the first floating diffusion node FD1 may decrease. In this case, the voltage level of the pixel signal PIX may be the HCG-signal level. During a time period from t7 to t8, the voltage level of the ramp signal RAMP may decrease. The counter CNT may count a time point at which the voltage level of the first input IN1 is the same as the voltage level of the second input IN2. A counting value may correspond to the HCG-signal level.

The counter CNT may output the digital signal DS including a difference between the counting value corresponding to the HCG-signal level and the counting value corresponding to the HCG-reset level. The HCG-reset level and the HCG-signal level may include a first noise generated due to the reset operation performed before the 0-th time point t0. Accordingly, the difference between the counting values may correspond to an HCG-signal in which the first noise is removed. For example, as the HCG-signal level is sampled after the HCG-reset level is sampled, the image sensor 100 may obtain an HCG-signal component in which a first noise component is completely or significantly removed (e.g., complete sampling may be performed).

In a second auto-zero period AZR2 from t8 to t10, the image sensor 100 may perform a second auto-zero operation. At the eighth time point t8, the dual conversion gain transistor DC may be turned on in response to the dual conversion signal VDC of logic high. In this case, a voltage level of the pixel signal PIX may be determined based on charges stored in the expanded floating diffusion node (e.g., including the first floating diffusion node FD1 and the second floating diffusion node FD2). Meanwhile, during a time period from t8 to t9, the transfer transistor TG may be turned on in response to the transfer signal VTG of logic high. In this case, the charges generated by the photoelectric conversion element PD may move to the expanded floating diffusion node. Accordingly, the pixel signal PIX may have the LCG-signal level.

Meanwhile, during a time period from t9 to t10, the comparator CMP may perform the second auto-zero operation, based on the auto zero signal AZ of logic high. Accordingly, a voltage level of the first input IN1 corresponding to the ramp signal RAMP and a voltage level of the second input IN2 corresponding to the pixel signal PIX may be adjusted to a second auto-zero voltage Vaz2. For example, the comparator CMP may perform the second auto-zero operation based on the pixel signal PIX having the LCG-signal level. Accordingly, the second auto-zero voltage Vaz2 may be determined based on the pixel signal PIX having the LCG-signal level and the voltage level of the ramp signal RAMP.

In an LCG-signal sampling period LCG-SIG from t10 to t12, the image sensor 100 may sample a signal level in the LCG mode. At the tenth time point t10, the first offset os1 may be applied to the ramp signal RAMP. During a time period from t11 to t12, the voltage level of the ramp signal RAMP may decrease. The counter CNT may count a time point at which the voltage level of the first input IN1 is the same as the voltage level of the second input IN2. A counting value may correspond to the LCG-signal level.

In an LCG-reset sampling period LCG-RST from t12 to t15, the image sensor 100 may sample a reset level in the LCG mode. During a time period from t12 to t13, the reset transistor RST may be turned on in response to the reset signal VRST of logic high. For example, the reset operation may be performed in the LCG mode. Accordingly, the voltage level of the pixel signal PIX may be the LCG-reset level. During a time period from t14 to t15, the voltage level of the ramp signal RAMP may decrease. The counter CNT may count a time point at which the voltage level of the first input IN1 is the same as the voltage level of the second input IN2. A counting value may correspond to the LCG-reset level.

The counter CNT may output the digital signal DS including a difference between the counting value corresponding to the LCG-signal level and the counting value corresponding to the LCG-reset level. Meanwhile, the LCG-signal level may include the first noise generated due to the reset operation performed before the 0-th time point t0. In contrast, the LCG-reset level may include a second noise generated due to the reset operation performed in the LCG-reset sampling period LCG-RST. Because the first noise and the second noise are generated by the reset operations performed at different time points, the first noise and the second noise may have different values (e.g., levels of the first noise and the second noise may be different). Accordingly, a difference between the counting values corresponding to the LCG levels may include a noise component, wherein the noise component is a difference between the first noise and the second noise. For example, even though the image sensor 100 performs CDS based on the LCG-reset level and the LCG-signal level, the noise corresponding to the LCG level may not be completely removed (e.g., incomplete sampling may be performed).

In other words, as illustrated in FIG. 4, when the image sensor 100 performs the readout operation in the RSSR manner, incomplete sampling may be performed on the LCG levels. This may mean that the performance of the image sensor 100 is reduced.

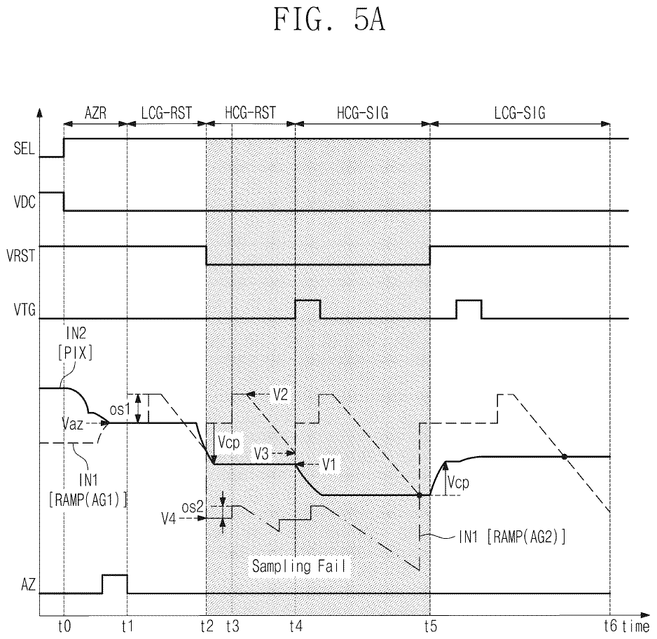

FIGS. 5A and 5B are diagrams for describing another example of an operation of an image sensor of FIG. 1. FIG. 5A is a timing diagram for describing an example of an operation of the image sensor 100 performing the readout operation in the RRSS manner. Referring to FIG. 5A, In an auto-zero period AZR from t0 to t1, the image sensor 100 may perform the auto-zero operation based on the LCG-reset level. In this case, voltages of the first input IN1 and the second input IN2 may be adjusted to an auto-zero voltage Vaz.

In an LCG-reset sampling period LCG-RST from t1 to t2, the image sensor 100 may sample a reset level in the LCG mode. During the LCG-reset sampling period LCG-RST, after the first offset os1 is applied to the ramp signal RAMP, the ramp signal RAMP may decrease. The counter CNT may count a time point at which the voltage level of the first input IN1 is the same as the voltage level of the second input IN2. A counting value may correspond to the LCG-reset level. Meanwhile, in the LCG-reset sampling period LCG-RST, an analog gain of the ramp signal RAMP may be a first analog gain AG1.

The analog gain may correspond to a slope of the ramp signal RAMP. For example, as the absolute value of the slope of the ramp signal RAMP becomes greater, the analog gain of the ramp signal RAMP may become smaller.

In an HCG-reset sampling period HCG-RST from t2 to t3, the image sensor 100 may sample a reset level in the HCG mode. At the second time point t2, the dual conversion signal VDC may transition to logic high to logic low, and thus, the dual conversion gain transistor DC may be turned off. Meanwhile, as the voltage level of the dual conversion signal VDC changes, due to the coupling phenomenon, the voltage level of the first floating diffusion node FD1 may decrease as much as a coupling voltage Vcp. In this case, the voltage level of the pixel signal PIX may also decrease as much as the coupling voltage Vcp. Accordingly, the voltage level of the second input IN2 (e.g., the HCG-reset level) may be a first voltage V1 obtained by subtracting the coupling voltage Vcp from the auto-zero voltage Vaz. The first voltage V1 may correspond to the HCG-reset level.

For example, the ramp signal RAMP may have the same analog gain in the LCG mode and the HCG mode (e.g., the ramp signal RAMP may have the first analog gain AG1 in the LCG mode and the HCG mode). In this case, the voltage level of the second input IN2 corresponding to the ramp signal RAMP may change based on the auto-zero voltage Vaz regardless of a conversion gain mode. For HCG-reset sampling, at a third time point t3, the first offset os1 may be applied to the ramp signal RAMP. Accordingly, the voltage level of the first input IN1 may be a second voltage V2. During a time period from t3 to t4, the voltage level of the ramp signal RAMP may decrease. In this case, the voltage level of the first input IN1 may decrease from the second voltage V2 to a third voltage V3. Meanwhile, the third voltage V3 may be greater than the first voltage V1. According to the above description, a time point at which the voltage level of the first input IN1 is the same as the voltage level of the second input IN2 may not exist in a time period from t3 to t4. For example, during the HCG-reset sampling period HCG-RST, a counting value generated by the counter CNT may not correspond to the HCG-reset Level.

In an HCG-signal sampling period HCG-SIG from t4 to t5, the image sensor 100 may sample a signal level in the HCG mode. When the ramp signal RAMP has the same analog gain in the LCG mode and the HCG mode, during the HCG-signal sampling period HCG-SIG, the first offset os1 may be applied to the ramp signal RAMP, and then, the ramp signal RAMP may decrease. The counter CNT may count a time point at which the voltage level of the first input IN1 is the same as the voltage level of the second input IN2. A counting value may correspond to the HCG-signal level.

In an LCG-signal sampling period LCG-SIG from t5 to t6, the image sensor 100 may sample a signal level in the LCG mode. At the fifth time point t5, the dual conversion signal VDC may transition from logic low to logic high, and thus, due to the coupling phenomenon, the voltage level of the first floating diffusion node FD1 may increase as much as the coupling voltage Vcp. In this case, the voltage level of the second input IN2 may also increases as much as the coupling voltage Vcp. After the fifth time point t5, the transfer transistor TG may be turned on in response to the transfer signal VTG of logic high. Accordingly, the voltage level of the second input IN2 may have the LCG-signal level. During the LCG-signal sampling period LCG-SIG, after the first offset os1 is applied to the ramp signal RAMP, the ramp signal RAMP may decrease. The counter CNT may count a time point at which the voltage level of the first input IN1 is the same as the voltage level of the second input IN2. A counting value may correspond to the LCG-signal level.

Graphs illustrating an example of the ramp signals RAMP according to an analog gain are shown in FIG. 5B. Referring to FIGS. 1 and 5B, for example, the ramp signal generator 130 may adjust the slope of the ramp signal RAMP based on 0 V and may generate a ramp signal corresponding to an analog gain. For example, the ramp signal generator 130 may output a first ramp signal RAMP1 corresponding to the first analog gain AG1, may output a second ramp signal RAMP2 corresponding to the second analog gain AG2, and may output a third ramp signal RAMP3 corresponding to a third analog gain AG3. For example, the second analog gain AG2 may be two times the first analog gain AG1, and the third analog gain AG3 may be four times the first analog gain AG1.

The ramp signal generator 130 may generate the first ramp signal RAMP1 based on a first reference voltage Vref1 and the first offset os1. The ramp signal generator 130 may generate the first ramp signal RAMP1 decreasing from a voltage level, which is obtained by adding the first reference voltage Vref1 and the first offset os1, with a first slope.

The ramp signal generator 130 may generate the second ramp signal RAMP2 based on a second reference voltage Vref2 and a second offset os2. The ramp signal generator 130 may generate the second ramp signal RAMP2 decreasing from a voltage level, which is obtained by adding the second reference voltage Vref2 and the second offset os2, with a second slope. In some example embodiments, the second reference voltage Vref2 may be smaller than the first reference voltage Vref1, the second offset os2 may be smaller than the first offset os1, and the absolute value of the second slope may be smaller than the absolute value of the first slope.

The ramp signal generator 130 may generate the third ramp signal RAMP3 based on a third reference voltage Vref3 and a third offset os3. The ramp signal generator 130 may generate the third ramp signal RAMP3 decreasing from a voltage level, which is obtained by adding the third reference voltage Vref3 and the third offset os3, with a third slope. In some example embodiments, the third reference voltage Vref3 may be smaller than the second reference voltage Vref2, the third offset os3 may be smaller than the second offset os2, and the absolute value of the third slope may be smaller than the absolute value of the second slope.

As described above, according to the example of FIG. 5B, the ramp signal generator 130 may change the analog gain of the ramp signal RAMP by changing the slope of the ramp signal RAMP based on 0 V. For examples, according to the example of FIG. 5B, the ramp signal generator 130 may generate the ramp signal RAMP while changing a reference voltage (e.g., to Vref1, Vref2, or Vref3) whenever the analog gain is changed.

Returning to FIG. 5A, the image sensor 100 may perform sampling by using the analog gain of the ramp signal RAMP differently set depending on a conversion gain. For example, the image sensor 100 may perform sampling on LCG levels based on the ramp signal RAMP of the first analog gain AG1 and may perform sampling on HCG levels based on the ramp signal RAMP of the second analog gain AG2. For example, the ramp signal generator 130 may change the analog gain of the ramp signal RAMP in the manner described with reference to FIG. 5B.

In this case, at the second time point t2, the ramp signal generator 130 may output the ramp signal RAMP (e.g., the second ramp signal RAMP2) corresponding to the second analog gain AG2. The reference voltage (e.g., Vref2 of FIG. 5B) of the ramp signal RAMP corresponding to the second analog gain AG2 may be smaller than reference voltage (e.g., Vref1 of FIG. 5B) of the ramp signal RAMP corresponding to the first analog gain AG1, and after the second time point t2, the auto-zero operation may not be separately performed. Accordingly, at the second time point t2, the voltage level of the first input IN1 may correspond to a sum of the offset voltage corresponding to the charges stored in the first capacitor C1 of the comparator CMP and the reference voltage (e.g., Vref2 of FIG. 5B) of the ramp signal RAMP. According to the above description, at the second time point t2, the voltage level of the ramp signal RAMP may decrease to a fourth voltage V4. During the HCG-reset sampling period HCG-RST, the ramp signal RAMP may change based on the fourth voltage V4 (e.g., the ramp signal RAMP may decrease after the second offset os2 is applied to the ramp signal RAMP). In some example embodiments, the fourth voltage V4 may be lower than the first voltage V1. According to the above description, the HCG-reset sampling period HCG-RST may not include a time point at which the voltage level of the first input IN1 is the same as the voltage level of the second input IN2.

The counter CNT may output the digital signal DS including a difference between the counting value corresponding to the LCG-signal level and the counting value corresponding to the LCG-reset level. However, as described above, when the readout operation is performed in the RRSS manner, the counter CNT may fail to generate a counting value corresponding to the HCG-reset level. In this case, the counter CNT fails to output the digital signal DS including a difference between the counting value corresponding to the HCG-signal level and the counting value corresponding to the HCG-reset level. For example, the image sensor 100 may fail to sample the HCG levels.

For example, to sample the HCG levels successfully, unlike the example illustrated in FIG. 5A, the image sensor 100 may additionally perform the auto-zero operation after the third time point t3. In this case, the image sensor 100 may successfully sample the HCG levels. However, in the LCG-signal sampling period, the ramp signal RAMP may be generated based on a new auto-zero voltage. According to the above description, in the image sensor 100, the sampled LCG-signal level may not be correlated to the LCG-reset level sampled in the LCG-reset sampling period. In other words, the image sensor 100 may fail to sample the LCG levels.

As described with reference to FIGS. 5A and 5B, when the image sensor 100 of FIG. 1 performs the readout operation in the RRSS manner, the image sensor 100 may fail to sample the HCG levels. To solve or improve upon the above issue, for example, unlike the example illustrated in FIG. 1, the image sensor 100 may be implemented to include two ADCs connected to the column line CL. In this case, for example, one ADC may be configured to generate the digital signal DS by performing the auto-zero operation based on a first ramp signal (e.g., RAMP1 of FIG. 5B) and the LCG-reset level and then performing sampling on the LCG levels, and the other ADC may be configured to generate the digital signal DS by performing the auto-zero operation based on a second ramp signal (e.g., RAMP2 of FIG. 5B) and the HCG-reset level and then performing sampling on the HCG levels. In this case, the incomplete sampling described with reference to FIG. 4 may not be performed. However, as the number of ADCs increases, the area of the ADC circuit 140 may excessively increase.

According to some example embodiments, the image sensor 100 may be implemented in a structure in which only one ADC is connected to each column line CL. Also, the image sensor 100 may perform the readout operation of the RRSS manner by sampling levels based on an adjustment offset oa and the ramp signal RAMP, the reference voltage of which does not change even though an analog gain is changed. Accordingly, the noise removal performance of the image sensor 100 may be improved without increasing the area. An operation of the image sensor 100 according to some example embodiments will be described in detail with reference to the following drawings.

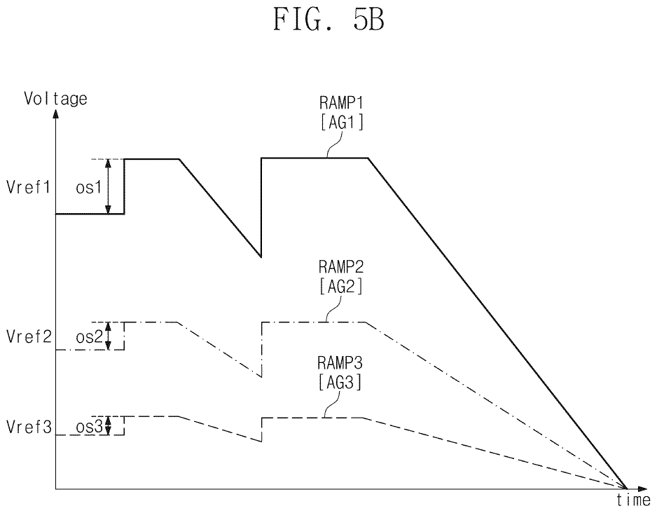

FIG. 6 is a timing diagram for describing an operation of an image sensor of FIG. 1 according to some example embodiments. Referring to FIGS. 1 and 6, the image sensor 100 may perform the readout operation based on the RRSS manner. In FIG. 6, the image sensor 100 may perform the readout operation based on the ramp signal RAMP corresponding to the first analog gain AG1 in the HCG mode and the LCG mode (e.g., the analog gain of the ramp signal RAMP may not be changed even though a conversion gain is changed).

Before a 0-th time point t0, the reset transistor RST and the dual conversion gain transistor DC may be turned on in response to the reset signal VRST of logic high and the dual conversion signal VDC of logic high, and the transfer transistor TG and the selection transistor SEL may be turned off in response to the transfer signal VTG of logic low and the selection signal VSEL of logic low. In this case, the image sensor 100 may perform the reset operation on the pixel PX.

During the auto-zero period AZR from t0 to t2, the image sensor 100 may perform the auto-zero operation (e.g., in response to the auto zero signal AZ of logic high).

At the 0-th time point t0, the reset transistor RST may be turned off in response to the reset signal VRST of logic low, and the selection transistor SEL may be turned on in response to the selection signal VSEL of logic high. In this case, the pixel PX may output the pixel signal PIX having the LCG-reset level.

At the first time point t1, the voltage level of the dual conversion signal VDC may transition from logic high to logic low, and thus, the dual conversion gain transistor DC may be turned off. Also, as the voltage level of the dual conversion signal VDC changes, due to the coupling phenomenon, the voltage level of the first floating diffusion node FD1 may decrease as much as the coupling voltage Vcp. In this case, the voltage level of the pixel signal PIX may also decrease as much as the coupling voltage Vcp. Accordingly, the voltage level of the second input IN2 (e.g., the HCG-reset level) may decrease as much as the coupling voltage Vcp. Meanwhile, the voltage level of the second input IN2 may correspond to the HCG-reset level.

During a time period from t1 to t2, the comparator CMP may perform the auto-zero operation, based on the auto zero signal AZ of logic high. Accordingly, a voltage level of the first input IN1 corresponding to the ramp signal RAMP and a voltage level of the second input IN2 corresponding to the pixel signal PIX may be adjusted to the auto-zero voltage Vaz. Meanwhile, unlike the case of FIGS. 4, 5A, and 5B, the image sensor 100 according to some example embodiments may perform the auto-zero operation based on the HCG-reset level.

At the second time point t2, the voltage level of the dual conversion signal VDC may transition from logic low to logic high, and thus, the dual conversion gain transistor DC may be turned on. As the voltage level of the dual conversion signal VDC changes, due to the coupling phenomenon, the voltage level of the first floating diffusion node FD1 may increase as much as the coupling voltage Vcp. In this case, the voltage level of the pixel signal PIX and the voltage level of the second input IN2 may also increase as much as the coupling voltage Vcp. Meanwhile, the voltage level of the second input IN2 may correspond to the LCG-reset level.

In an LCG-reset sampling period LCG-RST from t2 to t4, the image sensor 100 may sample a reset level in the LCG mode. At the third time point t3, as the adjustment offset oa is applied to the ramp signal RAMP, the voltage level of ramp signal RAMP may be an adjustment voltage Va. The voltage level of the adjustment voltage Va may be higher than the LCG-reset level. In some example embodiments, the adjustment offset oa may have a value obtained by adding the first offset os1 corresponding to the first analog gain AG1 and a compensation offset oc. In some example embodiments, the magnitude of the compensation offset oc may be in advance determined based on the magnitude of the coupling voltage Vcp. During a time period from t3 to t4, the voltage level of the ramp signal RAMP may decrease. The counter CNT may count a time point at which the voltage level of the first input IN1 is the same as the voltage level of the second input IN2. A counting value may correspond to the LCG-reset level.

Meanwhile, at the fourth time point t4, the voltage level of the dual conversion signal VDC may transition from logic high to logic low, and thus, the dual conversion gain transistor DC may be turned off. As the voltage level of the dual conversion signal VDC changes, due to the coupling phenomenon, the voltage level of the second input IN2 may decrease as much as the coupling voltage Vcp. The voltage level of the second input IN2 may correspond to the HCG-reset level.

In an HCG-reset sampling period HCG-RST from t4 to t6, the image sensor 100 may sample a reset level in the HCG mode. At the fifth time point t5, the first offset os1 may be applied to the ramp signal RAMP. Afterwards, the voltage level of the ramp signal RAMP may decrease. The counter CNT may count a time point at which the voltage level of the first input IN1 is the same as the voltage level of the second input IN2. A counting value may correspond to the HCG-reset level.

In an HCG-signal sampling period HCG-SIG from t6 to t7, the image sensor 100 may sample a signal level in the HCG mode. At the HCG-signal sampling period HCG-SIG, after the first offset os1 is applied to the ramp signal RAMP, the ramp signal RAMP may decrease. The counter CNT may count a time point at which the voltage level of the first input IN1 is the same as the voltage level of the second input IN2. A counting value may correspond to the HCG-signal level.

The ramp signal RAMP may change based on the auto-zero voltage Vaz adjusted based on the HCG-reset level. Also, in the case of sampling the LCG levels, the adjustment offset oa may be applied to the ramp signal RAMP. Accordingly, according to some example embodiments, unlike the case of FIG. 5A, the image sensor 100 may successfully sample the HCG levels. In some example embodiments, the adjustment offset oa may be greater than a voltage difference of the LCG-reset level and the HCG-reset level.

In an LCG-signal sampling period LCG-SIG from t7 to t8, the image sensor 100 may sample a signal level in the LCG mode. At the seventh time point t7, the voltage level of the dual conversion signal VDC may transition from logic low to logic high, and thus, the dual conversion gain transistor DC may be turned on. As the voltage level of the dual conversion signal VDC changes, due to the coupling phenomenon, the voltage level of the second input IN2 may increase as much as the coupling voltage Vcp. In the LCG-signal sampling period LCG-SIG, after the adjustment offset oa is applied to the ramp signal RAMP, the ramp signal RAMP may decrease. The counter CNT may count a time point at which the voltage level of the first input IN1 is the same as the voltage level of the second input IN2. A counting value may correspond to the LCG-signal level.

As described above in FIG. 6, according to some example embodiments, the image sensor 100 may perform the auto-zero operation only once during the readout period from t0 to t8. For example, the image sensor 100 may perform the auto-zero operation only once while performing analog-to-digital conversion by comparing the LCG-reset level, the HCG-reset level, the HCG-signal level, and the LCG-signal level with the ramp signal RAMP.

Meanwhile, all of the LCG-reset level, the HCG-reset level, the HCG-signal level, and the LCG-signal level may only include the first noise generated by only one reset operation (e.g., the reset operation before the 0-th time point t0). Accordingly, unlike the case of FIG. 4, the image sensor 100 may perform complete sampling on the LCG levels as well as the HCG levels.

Alternatively or additionally, as described above, according to some example embodiments, the image sensor 100 may perform the auto-zero operation based on the HCG-reset level which becomes lower due to the coupling phenomenon and may sample the LCG levels based on the adjustment offset oa. Accordingly, according to some example embodiments, the image sensor 100 which is implemented in a structure in which only one ADC is included per column line CL and is capable of performing the readout operation in the RRSS manner may be provided. This may mean that the noise removal performance of the image sensor 100 is improved without increasing the area, compared to the example of FIG. 4.

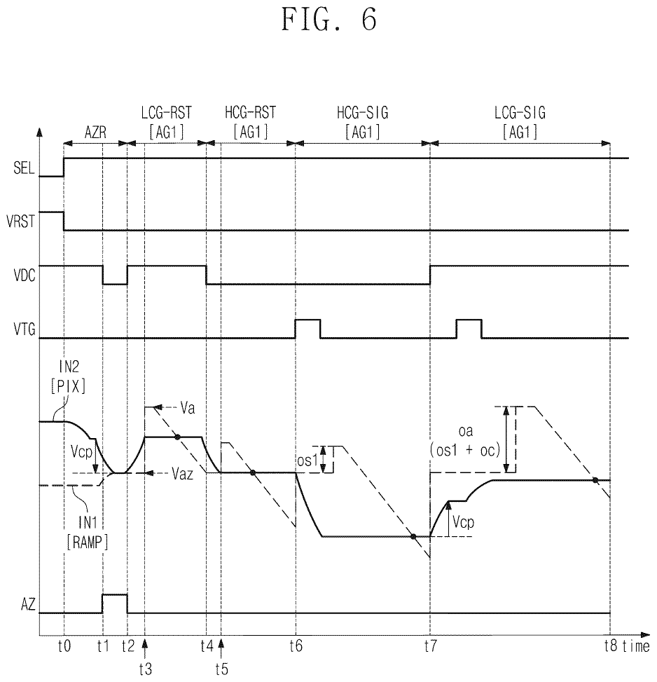

FIG. 7 is a block diagram illustrating a ramp signal generator of FIG. 1. Referring to FIGS. 1 and 7, the ramp signal generator 130 may include a ramp clock generator 131, a ramp offset controller 132, and a signal generator 133. The ramp clock generator 131 may receive analog gain information AG_info. In some example embodiments, the ramp clock generator 131 may receive the analog gain information AG_info from the timing controller 160. The analog gain information AG_info may include information about an analog gain of the ramp signal RAMP corresponding to the HCG mode and information about an analog gain of the ramp signal RAMP corresponding to the LCG mode. The ramp clock generator 131 may output a ramp clock RAMP_clk corresponding to a current analog gain of the ramp signal RAMP based on the analog gain information AG_info.

For example, the current analog gain of the ramp signal RAMP may be, or may correspond to, the first analog gain AG1. In this case, the ramp clock generator 131 may generate a first ramp clock RAMP_clk1. For example, the current analog gain of the ramp signal RAMP may be, or may correspond to, the second analog gain AG2 being two times the first analog gain AG1. In this case, the ramp clock generator 131 may divide the first ramp clock RAMP_clk1 by half to output a second ramp clock RAMP_clk2. For example, the current analog gain of the ramp signal RAMP may be, or may correspond to, the third analog gain AG3 being four times the first analog gain AG1. In this case, the ramp clock generator 131 may divide the first ramp clock RAMP_clk1 by ¼ to output a third ramp clock RAMP_clk 3.

The ramp offset controller 132 may receive the analog gain information AG_info and adjustment offset information info_oc. The ramp offset controller 132 may determine the magnitude of an offset of the ramp signal RAMP corresponding to the HCG mode and the magnitude of an offset of the ramp signal RAMP corresponding to the LCG mode based on the analog gain information AG_info and the adjustment offset information info_oc. The ramp offset controller 132 may output an offset control signal CTRL_os for controlling offset magnitudes of the HCG mode and the LCG mode so as to be set to the determined offset magnitudes.

For example, the HCG levels may be sampled based on the ramp signal RAMP of the first analog gain AG1, and the LCG levels may be sampled based on the ramp signal RAMP of the second analog gain AG2. In this case, when the HCG levels are sampled, the ramp offset controller 132 may output the offset control signal CTRL_os corresponding to the first offset os1. Alternatively or additionally, when the LCG levels are sampled, the ramp offset controller 132 may output the offset control signal CTRL_os corresponding to the adjustment offset oa. In this case, the adjustment offset oa may have a value obtained by adding the first offset os1 and the compensation offset oc.

The signal generator 133 may receive a ramp enable signal RAMP_EN, the offset control signal CTRL_os, and the ramp clock RAMP_clk. The signal generator 133 may generate the ramp signal RAMP based on the ramp enable signal RAMP_EN, the offset control signal CTRL_os, and the ramp clock RAMP_clk. The signal generator 133 may change the analog gain of the ramp signal RAMP based on the ramp clocks RAMP_clk2 and RAMP_clk3 obtained by dividing the first ramp clock RAMP_clk1. According to the above description, unlike the case of FIG. 5B, the reference voltage of the ramp signal RAMP may not change even though the analog gain is changed.

Meanwhile, in FIG. 7, the description is given based on the case where the ramp signal generator 130 generates the ramp signal RAMP corresponding to the first to third analog gains AG1 to AG3, but example embodiments are not limited thereto. For example, the ramp signal generator 130 may adjust the ramp clock RAMP_clk to generate the ramp signal RAMP corresponding to various analog gains.

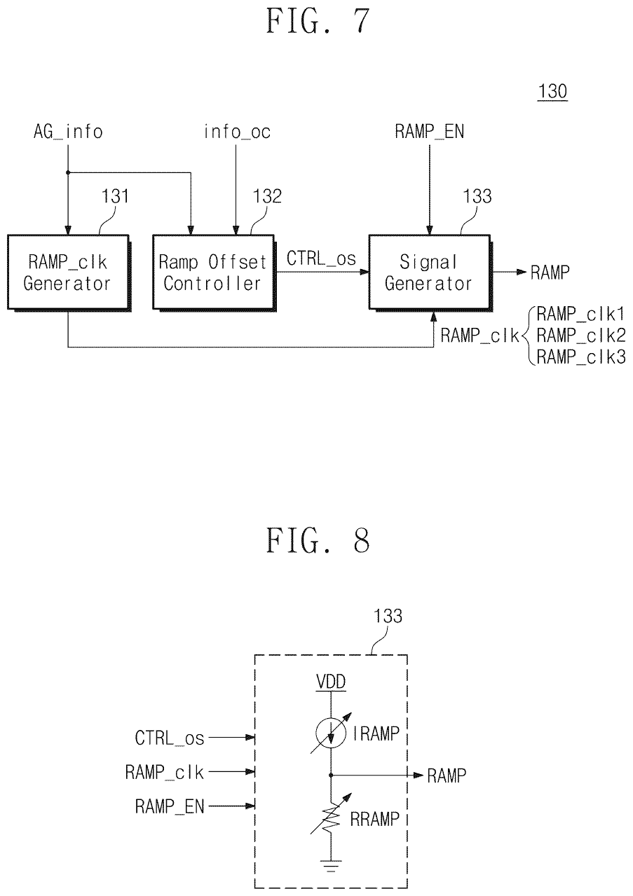

FIG. 8 is a circuit diagram for describing an example of a signal generator of FIG. 7. The signal generator 133 may include a ramp current source IRAMP and a ramp resistor RRAMP, the ramp current source IRAMP may be connected between the pixel power supply voltage VDD and the ramp resistor RRAMP, and the ramp resistor RRAMP may be connected between a ground voltage and the ramp current source IRAMP. The ramp signal RAMP may be generated while a current flows from the ramp current source IRAMP to the ramp resistor RRAMP. In some example embodiments, the ramp current source IRAMP may be a variable current source, and the ramp resistor RRAMP may be a variable resistor.

The signal generator 133 may apply an offset to the ramp signal RAMP in response to the ramp enable signal RAMP_EN and the offset control signal CTRL_os. For example, the signal generator 133 may adjust the offset by adjusting a current level of the ramp current source IRAMP. Alternatively or additionally, the signal generator 133 may adjust the magnitude of the offset to be applied to the ramp signal RAMP for each analog gain in response to the offset control signal CTRL_os.

The signal generator 133 may decrease the voltage level of the ramp signal RAMP, based on the ramp clock RAMP_clk. For example, the signal generator 133 may receive the activated ramp enable signal RAMP_EN. In this case, the signal generator 133 may decrease the current level of the ramp current source IRAMP as much as a specific level at each edge (e.g., a rising edge or a falling edge) of the ramp clock RAMP_clk. Accordingly, the voltage level of the ramp signal RAMP may decrease.

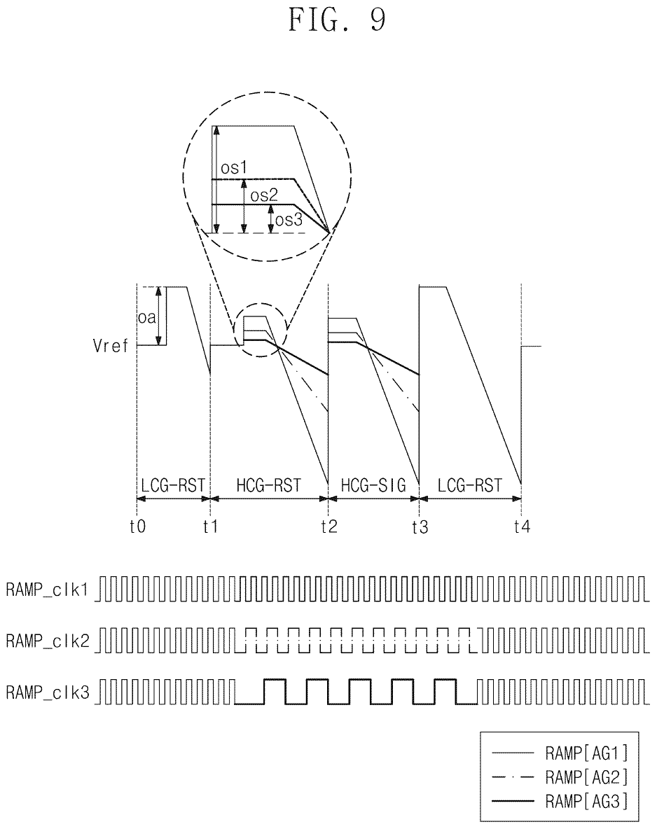

FIG. 9 is a diagram for describing an example of a ramp signal generated by a ramp signal generator of FIG. 7. FIG. 9 shows the ramp signal RAMP which is generated when the ramp signal RAMP has the same analog gain in the LCG mode and the HCG mode or when the analog gain of the ramp signal RAMP in the HCG mode is greater than the analog gain of the ramp signal RAMP in the LCG mode. Referring to FIGS. 1 and 7 to 9, during the LCG-reset sampling period LCG-RST from t0 to t1, the ramp signal generator 130 may output the ramp signal RAMP corresponding to the first analog gain AG1 based on the first ramp clock RAMP_clk1. The ramp signal generator 130 may apply the adjustment offset oa to the ramp signal RAMP of the reference voltage Vref and may then decrease the ramp signal RAMP. The adjustment offset oa may have a value obtained by adding the first offset os1 and the compensation offset oc.

During the HCG-reset sampling period HCG-RST from t1 to t2, the ramp signal generator 130 may output the ramp signal RAMP corresponding to any one of the first to third analog gains AG1 to AG3 without changing the level of the reference voltage Vref.

For example, the HCG levels may be sampled based on the ramp signal RAMP corresponding to the first analog gain AG1. In this case, after the ramp signal generator 130 applies the first offset os1 to the ramp signal RAMP having the reference voltage Vref, the ramp signal generator 130 may decrease the voltage of the ramp signal RAMP based on the first ramp clock RAMP_clk1 and may output the ramp signal RAMP corresponding to the first analog gain AG1.

For example, the HCG levels may be sampled based on the ramp signal RAMP corresponding to the second analog gain AG2. In this case, after the ramp signal generator 130 applies the second offset os2 to the ramp signal RAMP having the reference voltage Vref, the ramp signal generator 130 may decrease the voltage of the ramp signal RAMP based on the second ramp clock RAMP_clk2 obtained by dividing the first ramp clock RAMP_clk1 by half and may output the ramp signal RAMP corresponding to the second analog gain AG2.

For example, the HCG levels may be sampled based on the ramp signal RAMP corresponding to the third analog gain AG3. In this case, after the ramp signal generator 130 applies the third offset os3 to the ramp signal RAMP having the reference voltage Vref, the ramp signal generator 130 may decrease the voltage of the ramp signal RAMP based on the third ramp clock RAMP_clk3 obtained by dividing the first ramp clock RAMP_clk1 by ¼ and may output the ramp signal RAMP corresponding to the third analog gain AG3.

In some example embodiments, the ramp signal RAMP may have the same analog gain in the HCG mode and the LCG mode. In this case, the ramp signal generator 130 may generate the ramp signal RAMP based on the adjustment offset oa in an operation period corresponding to the LCG mode.

In some example embodiments, the ramp signal RAMP may have different analog gains in the HCG mode and the LCG mode. In this case, the ramp signal generator 130 may generate the ramp signal RAMP based on the adjustment offset oa in an operation period corresponding to the ramp signal RAMP of a low analog gain.

As described above, the ramp signal generator 130 may change the analog gain of the ramp signal RAMP based on the divided ramp clock RAMP_clk. According to the above description, even though the analog gain of the ramp signal RAMP changes, the reference voltage of the ramp signal RAMP may not change.

During the HCG-signal sampling period HCG-SIG from t2 to t3, the ramp signal generator 130 may generate the same ramp signal RAMP as the HCG-reset sampling period HCG-RST.

During the LCG-signal sampling period LCG-SIG from t3 to t4, the ramp signal generator 130 may generate the same ramp signal RAMP as the LCG-reset sampling period LCG-RST.

As described with reference to FIGS. 7 to 9, unlike the example of FIG. 5B, the ramp signal generator 130 according to some example embodiments may generate the ramp signal RAMP whose reference voltage Vref does not change even though the analog gain changes. Meanwhile, in FIGS. 7 to 9, the description is given as the ramp signal generator 130 generates the ramp signal RAMP whose reference voltage Vref does not change regardless of the analog gain by adjusting the ramp clock RAMP_clk, but example embodiments are not limited thereto. For example, the ramp signal generator 130 may be implemented to generate the ramp signal RAMP whose reference voltage Vref does not change even though the analog gain changes, in various manners.

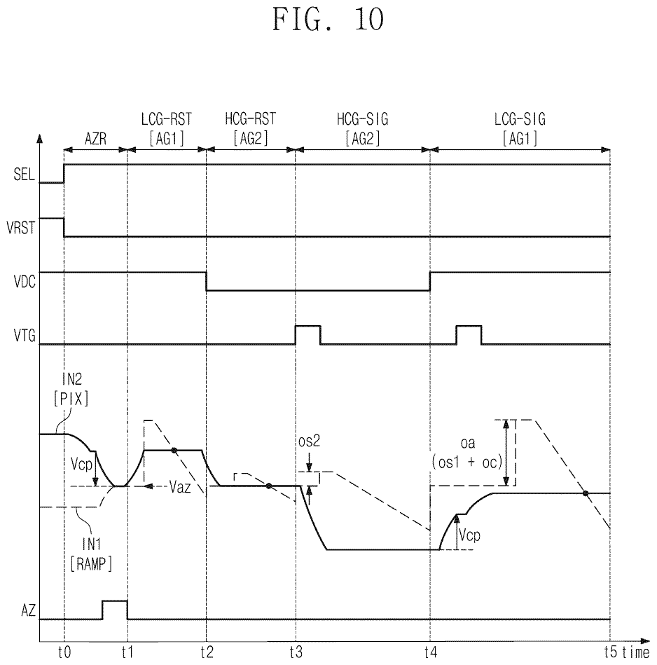

FIG. 10 is a timing diagram for describing another example of an operation of an image sensor of FIG. 1 according to some example embodiments. In FIG. 10, the ramp signal generator 130 may generate the ramp signal RAMP in the method described with reference to FIGS. 7 to 9. Accordingly, unlike the case of FIG. 5B, the reference voltage Vref of the ramp signal RAMP may not change even other the analog gain of the ramp signal RAMP is changed. Meanwhile, the image sensor 100 may perform sampling on LCG levels based on the ramp signal RAMP of the first analog gain AG1 and may perform sampling on HCG levels based on the ramp signal RAMP of the second analog gain AG2. In this case, for example, the second analog gain AG2 may be two times the first analog gain AG1. However, example embodiments are not limited thereto. For example, the analog gain of the ramp signal RAMP may be variously changed.

Because the operation in each of the operation periods LCG-RST, HCG-RST, HCG-SIG, and LCG-SIG is described with reference to FIG. 6, below, a difference between FIGS. 6 and 10 will be described.

In the auto-zero period AZR from t0 to t1, the image sensor 100 may perform the auto-zero operation. In detail, between the 0-th time point t0 and the first time point t1, the comparator CMP may perform the auto-zero operation, based on the auto zero signal AZ of logic high. Accordingly, a voltage level of the first input IN1 corresponding to the ramp signal RAMP and a voltage level of the second input IN2 corresponding to the HCG-reset level may be adjusted to the auto-zero voltage Vaz. For example, according to some example embodiments, the comparator CMP may perform the auto-zero operation based on a conversion gain mode (e.g., the HCG mode) in which the analog gain is high.

In the LCG-reset sampling period LCG-RST from t1 to t2, the image sensor 100 may sample a reset level in the LCG mode. After the image sensor 100 applies the adjustment offset oa to the ramp signal RAMP, the image sensor 100 may sample the LCG-reset level while decreasing the voltage level of the ramp signal RAMP. In some example embodiments, the adjustment offset oa may have a value obtained by adding the first offset os1 corresponding to the first analog gain AG1 and the compensation offset oc. In some example embodiments, the magnitude of the compensation offset oc may be in advance determined based on the magnitude of the coupling voltage Vcp. As illustrated in FIG. 10, when the analog gain (e.g., the second analog gain AG2) of the HCG mode is smaller than the analog gain (e.g., the first analog gain AG1) of the LCG mode, the compensation offset oc may have a positive value. As described above, when the analog gain of the ramp signal RAMP in the HCG mode is greater than the analog gain of the ramp signal RAMP in the LCG mode, the magnitude of the adjustment offset oa may be greater than a voltage difference of the LCG-reset level and the HCG-reset level.

In the HCG-reset sampling period HCG-RST from t2 to t3, the image sensor 100 may sample a reset level in the HCG mode. At the second time point t2, the dual conversion signal VDC may transition from logic high to logic low, and thus, the dual conversion gain transistor DC may be turned off. For example, the pixel PX may operate in the HCG mode. Meanwhile, the analog gain of the ramp signal RAMP may be changed from the first analog gain AG1 to the second analog gain AG2. Meanwhile, as described above, the reference voltage Vref of the ramp signal RAMP may be maintained even though the analog gain is changed. Accordingly, at the second time point t2, the voltage level of the ramp signal RAMP may be the auto-zero voltage Vaz. After the image sensor 100 applies the second offset os2 to the ramp signal RAMP, the image sensor 100 may sample the HCG-reset level while decreasing the voltage level of the ramp signal RAMP.

In the HCG-signal sampling period HCG-SIG from t3 to t4, the image sensor 100 may sample a signal level in the HCG mode. After the image sensor 100 applies the second offset os2 to the ramp signal RAMP, the image sensor 100 may sample the HCG-signal level while decreasing the voltage level of the ramp signal RAMP. Meanwhile, the HCG-signal sampling period HCG-SIG may not include a time point at which the voltage level of the first input IN1 is the same as the voltage level of the second input IN2. In this case, during the HCG-signal sampling period HCG-SIG, a counting value generator by the counter CNT may have a saturated value. For example, the saturated value may mean a maximum value which the counting value is capable of having.

In the LCG-signal sampling period LCG-SIG from t4 to t5, the image sensor 100 may sample a signal level in the LCG mode. After the image sensor 100 applies the adjustment offset oa to the ramp signal RAMP, the image sensor 100 may sample the LCG-signal level while decreasing the voltage level of the ramp signal RAMP.

As described above, according to some example embodiments, the image sensor 100 may perform the auto-zero operation based on a reset level (e.g., the HCG-reset level) of a conversion gain mode (e.g., the HCG mode) in which the analog gain is high. Also, the image sensor 100 may sample levels of a conversion gain mode (e.g., the LCG mode) corresponding to the ramp signal RAMP whose analog gain is low, based on the adjustment offset oa. Accordingly, the image sensor 100 may perform complete sampling on the levels of the conversion gain mode (e.g., the LCG mode) corresponding to the ramp signal RAMP whose analog gain is low. Also, the image sensor 100 may generate the ramp signal RAMP whose reference voltage Vref does not change even though the analog gain is changed. Accordingly, even though the analog gain of the ramp signal RAMP increases while the image sensor 100 is operating, the image sensor 100 may perform complete sampling on the levels of the conversion gain mode (e.g., the HCG mode) corresponding to the ramp signal RAMP whose analog gain is high.

For example, according to some example embodiments, the image sensor 100 which is implemented in a structure in which only one ADC is included per column line CL and is capable of performing the readout operation in the RRSS manner may be provided. This may mean that the noise removal performance of the image sensor 100 is improved without increasing the area, compared to the example of FIG. 4.

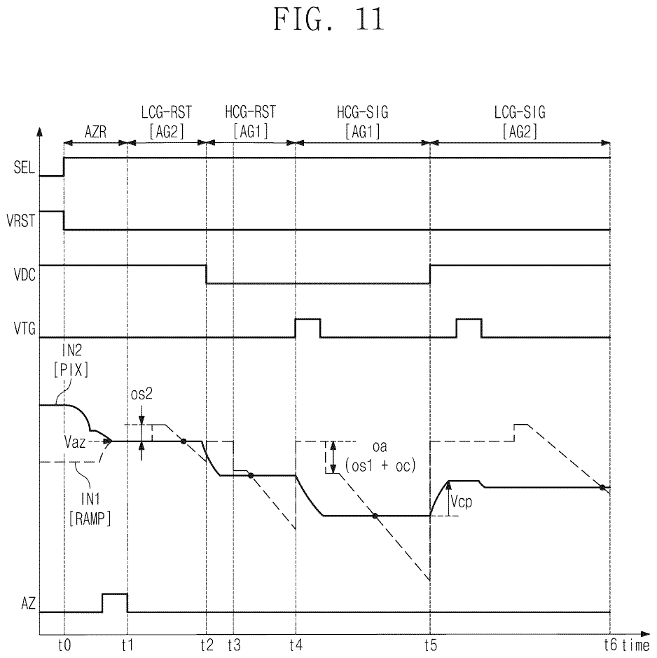

FIG. 11 is a timing diagram for describing another example of an operation of an image sensor of FIG. 1 according to some example embodiments. Unlike the case of FIG. 10, referring to FIG. 11, the image sensor 100 may perform sampling on LCG levels based on the ramp signal RAMP of the second analog gain AG2 and may perform sampling on HCG levels based on the ramp signal RAMP of the first analog gain AG1 lower than the second analog gain AG2. For example, in the embodiment of FIG. 11, the analog gain of the ramp signal RAMP in the LCG mode may be greater than the analog gain of the ramp signal RAMP in the HCG mode.

In this case, the image sensor 100 may sample the HCG levels, based on the adjustment offset oa. In this case, for example, the adjustment offset oa may have a value obtained by adding the first offset os1 and the compensation offset oc. Meanwhile, as illustrated in FIG. 11, when the analog gain (e.g., the second analog gain AG2) of the ramp signal RAMP in the LCG mode is greater than the analog gain (e.g., the first analog gain AG1) of the ramp signal RAMP in the HCG mode, the compensation offset oc may have a negative value. According to the above description, when the HCG levels are sampled, the voltage level of the first input IN1 may be decreased from the auto-zero voltage Vaz as much as the adjustment offset oa and may then again decrease. Accordingly, the image sensor 100 may successfully sample the HCG levels. As described above, when the analog gain of the ramp signal RAMP in the LCG mode is greater than the analog gain of the ramp signal RAMP in the HCG mode, the magnitude of the adjustment offset oa may be smaller than the voltage difference of the LCG-reset level and the HCG-reset level.

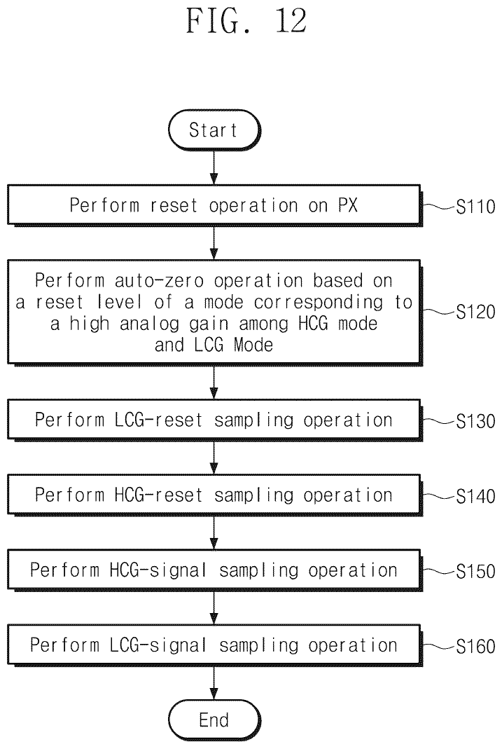

FIG. 12 is a flowchart for describing an operation method of an image sensor according to some example embodiments. FIG. 12 will be described with reference to FIGS. 1 to 3B and 6 to 11. Referring to FIG. 12, in operation S110, the image sensor 100 may perform the reset operation on the pixel PX. For example, the image sensor 100 may reset a floating diffusion node (e.g., an expanded floating diffusion node) by turning on the reset transistor RST and the dual conversion gain transistor DC.

In operation S120, the image sensor 100 may perform the auto-zero operation based on a reset level of a mode corresponding to a high analog gain from among the HCG mode and the LCG mode. Through the auto-zero operation, the voltage levels of the first input IN1 and the second input IN2 input to the comparator CMP may be adjusted to an auto-zero voltage.

In some example embodiments, like the case of FIG. 6, the analog gain corresponding to the HCG mode may be the same as the analog gain of the LCG mode. In this case, the image sensor 100 may perform the auto-zero operation based on the HCG-reset level.

In operation S130, the image sensor 100 may perform the LCG-reset sampling operation. In detail, the image sensor 100 may sample the LCG-reset level by comparing the pixel signal PIX having the LCG-reset level with the ramp signal RAMP. In some example embodiments, the analog gain corresponding to the HCG mode may be greater than the analog gain corresponding to the LCG mode. In this case, the image sensor 100 may perform the LCG-reset sampling operation based on the adjustment offset oa.

In operation S140, the image sensor 100 may perform the HCG-reset sampling operation. In detail, the image sensor 100 may sample the HCG-reset level by comparing the pixel signal PIX having the HCG-reset level with the ramp signal RAMP. In some example embodiments, the analog gain corresponding to the LCG mode may be greater than the analog gain corresponding to the HCG mode. In this case, the image sensor 100 may perform the HCG-reset sampling operation based on the adjustment offset oa.

In operation S150, the image sensor 100 may perform the HCG-signal sampling operation. In detail, the image sensor 100 may sample the HCG-signal level by comparing the pixel signal PIX having the HCG-signal level with the ramp signal RAMP. In some example embodiments, the analog gain corresponding to the LCG mode may be greater than the analog gain corresponding to the HCG mode. In this case, the image sensor 100 may perform the HCG-reset sampling operation based on the adjustment offset oa.

In operation S160, the image sensor 100 may perform the LCG-signal sampling operation. In detail, the image sensor 100 may sample the LCG-signal level by comparing the pixel signal PIX having the LCG-signal level with the ramp signal RAMP. In some example embodiments, the analog gain corresponding to the HCG mode may be greater than the analog gain corresponding to the LCG mode. In this case, the image sensor 100 may perform the LCG-reset sampling operation based on the adjustment offset oa.

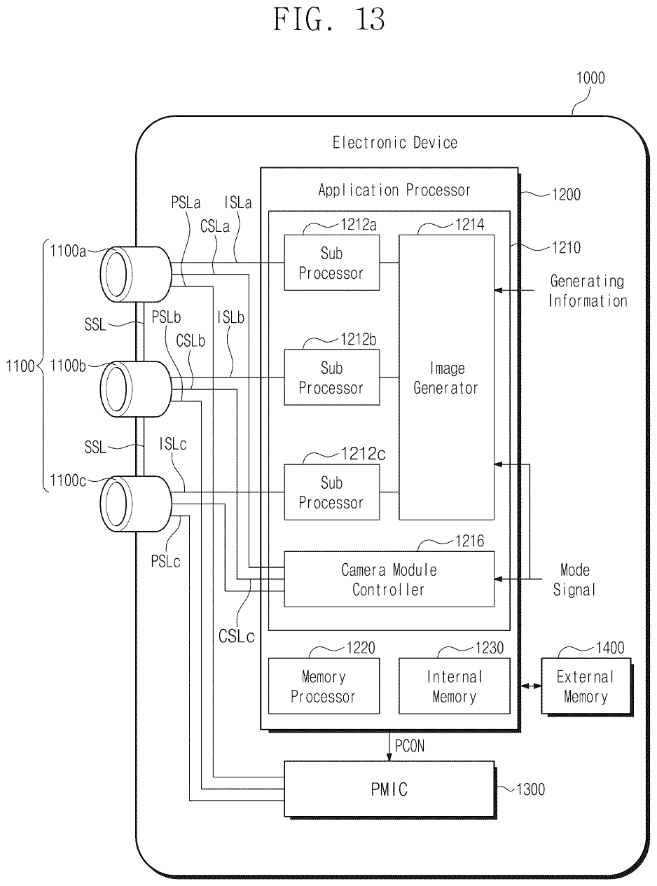

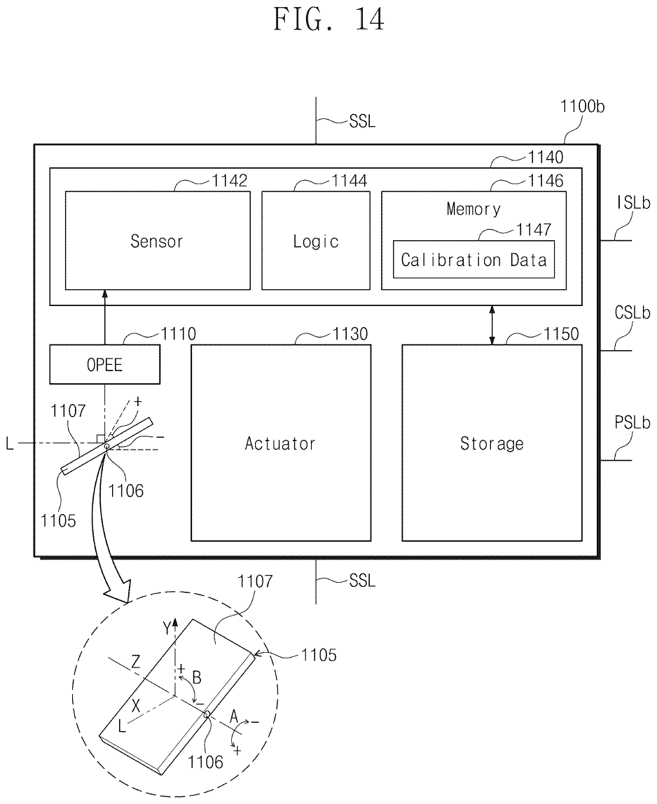

FIG. 13 is a block diagram of an electronic device including a multi-camera module. FIG. 14 is a block diagram illustrating a camera module of FIG. 13 in detail.

Referring to FIG. 13, an electronic device 1000 may include a camera module group 1100, an application processor 1200, a PMIC 1300, and an external memory 1400.

The camera module group 1100 may include a plurality of camera modules 1100a, 1100b, and 1100c. An electronic device including three camera modules 1100a, 1100b, and 1100c is illustrated in FIG. 13, but example embodiments are not limited thereto. In some example embodiments, the camera module group 1100 may be modified to include only two camera modules. Alternatively, in some example embodiments, the camera module group 1100 may be modified to include “n” camera modules (n being a natural number of 4 or more).

In some example embodiments, the image sensor 110 of FIG. 1 may be included in one or more of camera modules 1100a, 1100b, or 1100c in the camera module group 1100. But example embodiments are not limited thereto.

Below, a detailed configuration of the camera module 1100b will be more fully described with reference to FIG. 14, but the following description may be equally applied to the remaining camera modules 1100a and 1100c.

Referring to FIG. 14, the camera module 1100b may include a prism 1105, an optical path folding element (OPFE) 1110, an actuator 1130, an image sensing device 1140, and storage 1150.

The prism 1105 may include a reflecting plane 1107 of a light reflecting material and may change a path of a light “L” incident from the outside.

In some example embodiments, the prism 1105 may change a path of the light “L” incident in a first direction (X) to a second direction (Y) perpendicular to the first direction (X), Also, the prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B”. In this case, the OPFE 1110 may move in a third direction (Z) perpendicular to the first direction (X) and the second direction (Y).

In some example embodiments, as illustrated in FIG. 14, a maximum rotation angle of the prism 1105 in direction “A” may be equal to or smaller than 15 degrees in a positive A direction and may be greater than 15 degrees in a negative A direction, but example embodiments are not limited thereto.

In some example embodiments, the prism 1105 may move within approximately 20 degrees in a positive or negative B direction, between 10 degrees and 20 degrees, or between 15 degrees and 20 degrees; here, the prism 1105 may move at the same angle in the positive or negative B direction or may move at a similar angle within approximately 1 degree.

In some example embodiments, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. Here, “m” lens may move in the second direction (Y) to change an optical zoom ratio of the camera module 1100b. For example, when a default optical zoom ratio of the camera module 1100b is “Z”, the optical zoom ratio of the camera module 1100b may be changed to an optical zoom ratio of 3Z, 5Z, or 5Z or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144, and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb. Meanwhile, the image sensor 1142 of FIG. 14 may correspond to the image sensor 100 of FIG. 1.

The memory 1146 may store information, which is necessary for an operation of the camera module 1100b, such as calibration data 1147. The calibration data 1147 may include information necessary for the camera module 1100b to generate image data by using the light “L” provided from the outside. The calibration data 1147 may include, for example, information about the degree of rotation described above, information about a focal length, information about an optical axis, etc. In the case where the camera module 1100b is implemented in the form of a multi-state camera in which a focal length varies depending on a location of an optical lens, the calibration data 1147 may include a focal length value for each location (or state) of the optical lens and information about auto focusing.

The storage 1150 may store image data sensed through the image sensor 1142. The storage 1150 may be disposed outside the image sensing device 1140 and may be implemented in a shape where the storage 1150 and a sensor chip constituting the image sensing device 1140 are stacked. In some embodiments, the storage 1150 may be implemented with an electrically erasable programmable read only memory (EEPROM), but example embodiments are not limited thereto.

Referring together to FIGS. 13 and 14, in some embodiments, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some example embodiments, at least one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, example embodiments are not limited thereto.

In some example embodiments, at least one camera module (e.g., 1100c) among the plurality of camera modules 1100a, 1100b, and 1100c may be, for example, a vertical shape of depth camera extracting depth information by using an infrared ray (IR). In this case, the application processor 1200 may merge image data provided from the depth camera and image data provided from any other camera module (e.g., 1100a or 1100b) and may generate a three-dimensional (3D) depth image.

In some example embodiments, at least two camera modules (e.g., 1100a and 1100b) among the plurality of camera modules 1100a, 1100b, and 1100c may have different fields of view. In this case, the at least two camera modules (e.g., 1100a and 1100b) among the plurality of camera modules 1100a, 1100b, and 1100c may include different optical lens, but example embodiments are not limited thereto.

Also, in some example embodiments, fields of view of the plurality of camera modules 1100a, 1100b, and 1100c may be different. In this case, the plurality of camera modules 1100a, 1100b, and 1100c may include different optical lens, not limited thereto.

In some example embodiments, the plurality of camera modules 1100a, 1100b, and 1100c may be disposed to be physically separated from each other. For example, the plurality of camera modules 1100a, 1100b, and 1100c may not use a sensing area of one image sensor 1142, but the plurality of camera modules 1100a, 1100b, and 1100c may include independent image sensors 1142 therein, respectively.

Returning to FIG. 13, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216.

The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separated image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but example embodiments are not limited thereto.

Meanwhile, in some example embodiments, one sub image processor may be disposed to correspond to a plurality of camera modules. For example, the sub image processor 1212a and the sub image processor 1212c may be integrally implemented, not separated from each other as illustrated in FIG. 16; in this case, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information Generating Information or a mode signal.

In detail, the image generator 1214 may generate the output image by merging at least a portion of the image data respectively generated from the camera modules 1100a, 1100b, and 1100c having different fields of view, depending on the image generating information Generating Information or the mode signal. Also, the image generator 1214 may generate the output image by selecting one of the image data respectively generated from the camera modules 1100a, 1100b, and 1100c having different fields of view, depending on the image generating information Generating Information or the mode signal.

In some example embodiments, the image generating information Generating Information may include a zoom signal or a zoom factor. Also, in some embodiments, the mode signal may be, for example, a signal based on a mode selected from a user.

In the case where the image generating information Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b that is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, example embodiments are not limited thereto, and a way to process image data may be modified without limitation if necessary.

In some example embodiments, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One, e.g., only one of the plurality of camera modules 1100a, 1100b, and 1100c may be designated as a master camera (e.g., 1100b) depending on the image generating information Generating Information including a zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc separated from each other.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some example embodiments, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as a slave camera, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some example embodiments, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. In this case, the second speed may be 30 times or less the first speed.

The application processor 1200 may store the received image signals, for example, the encoded image signals in the memory 1230 provided therein or the external memory 1400 placed outside the application processor 1200. Afterwards, the application processor 1200 may read and decode the encoded image signals from the memory 1230 or the external memory 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the memory 1230 or the external memory 1400.

The PMIC 1300 may supply powers, for example, pixel power supply voltages to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

In response to a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. In this case, the power control signal PCON may include information about a camera module operating in the low-power mode and a set power level. Levels of the powers respectively provided to the plurality of camera modules 1100a, 1100b, and 1100c may be identical to each other or may be different from each other. Also, a level of a power may be dynamically changed.

According some example embodiments, an image sensor may perform a readout operation in a reset-reset-sig-sig (RRSS) manner without increasing the area of the image sensor. In this case, the image sensor in which noise removal performance is excellent without the increase in the area may be provided. Accordingly, the image sensor with improved performance and an operation method thereof are provided.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts been described with reference to embodiments thereof, it will be apparent to those of ordinary skill in the art that various changes and modifications may be made thereto without departing from the spirit and scope of the present disclosure as set forth in the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. An image sensor comprising:
a first pixel configured to sequentially output a first pixel signal having a first reset level corresponding to a first conversion gain, a second pixel signal having a second reset level corresponding to a second conversion gain different from the first conversion gain, a third pixel signal having a second signal level corresponding to the second conversion gain, and a fourth pixel signal having a first signal level corresponding to the first conversion gain, the output through a first column line;
a ramp signal generator configured to sequentially output a first ramp signal corresponding to a first analog gain, a second ramp signal corresponding to a second analog gain different from the first analog gain, a third ramp signal corresponding to the second analog gain, and a fourth ramp signal corresponding to the first analog gain; and
an analog-to-digital converter connected to the first column line, and configured to perform an auto-zero operation based on any one of the first reset level and the second reset level and to perform analog-to-digital conversion by comparing the first reset level and the first ramp signal, comparing the second reset level and the second ramp signal, comparing the second signal level and the third ramp signal, and comparing the first signal level and the fourth ramp signal,
wherein the analog-to-digital converter is configured to perform the auto-zero operation based on the first pixel signal, the second pixel signal, the third pixel signal, and the fourth pixel signal only once for a same comparing.

2. The image sensor of claim 1, wherein the second conversion gain is greater the first conversion gain.

3. The image sensor of claim 2, wherein the analog-to-digital converter is configured to perform the auto-zero operation based on the second reset level.

4. The image sensor of claim 3, wherein
the first ramp signal corresponds to a first offset,
the second ramp signal corresponds to a second offset,
a magnitude of the first offset is greater than a magnitude of the second offset, and
the magnitude of the first offset is greater than a voltage difference of the first reset level and the second reset level.

5. The image sensor of claim 4, wherein the analog-to-digital converter includes:
a comparator including a first input terminal configured to receive the first ramp signal and the fourth ramp signal, and a second input terminal connected to the first column line and configured to receive the first pixel signal, the second pixel signal, the third pixel signal, and the fourth pixel signal,
wherein the analog-to-digital converter is configured to adjust a voltage of the first input terminal and a voltage of the second input terminal an auto-zero voltage through the auto-zero operation.

6. The image sensor of claim 5, wherein,
the image sensor is configured to operate such that while the first reset level and the first ramp signal are compared, the voltage of the first input terminal changes from a first voltage to a second voltage, the first voltage obtained by adding the auto-zero voltage and the first offset, and
the image sensor is configured to operate such that while the second reset level and the second ramp signal are compared, the voltage of the first input terminal changes from a third voltage to a fourth voltage, the third voltage obtained by adding the auto-zero voltage and the second offset.

7. The image sensor of claim 3, wherein the ramp signal generator is configured to:
generate the first ramp signal corresponding to the first analog gain based on a first ramp clock; and
generate the second ramp signal corresponding to the second analog gain based on a second ramp clock,
wherein the image sensor is configured to generate the second ramp clock by dividing the first ramp clock.

8. The image sensor of claim 3, wherein the first pixel includes:
a photoelectric conversion element configured to accumulate charges in response to a light signal received from outside;
a transfer transistor connected between the photoelectric conversion element and a floating diffusion node;
a reset transistor configured to provide a reset voltage to the floating diffusion node;
a dual conversion gain transistor connected between the floating diffusion node and the reset transistor;
a source follower transistor configured to generate a pixel signal corresponding to a voltage of the floating diffusion node; and
a selection transistor connected to the source follower transistor, and configured to output the pixel signal to the first column line.

9. The image sensor of claim 8, wherein the image sensor is configured to operate such that while the auto-zero operation is performed, the dual conversion gain transistor is turned off.

10. The image sensor of claim 1, wherein the first column line is connected to one analog-to-digital converter.

11. An operation method of an image sensor which includes a first pixel configured to sequentially output a first pixel signal having a first reset level corresponding to a first conversion gain, a second pixel signal having a second reset level corresponding to a second conversion gain, a third pixel signal having a second signal level corresponding to the second conversion gain, and a fourth pixel signal having a first signal level corresponding to the first conversion gain, the output through a first column line, the method comprising:
performing a reset operation on the first pixel;
performing an auto-zero operation based on the second reset level;
performing a first reset sampling operation of comparing the first reset level and a first ramp signal corresponding to a first analog gain;
performing a second reset sampling operation of comparing the second reset level and a second ramp signal corresponding to a second analog gain;
performing a first signal sampling operation of comparing the second signal level and a third ramp signal corresponding to the second analog gain; and
performing a second signal sampling operation of comparing the first signal level and a fourth ramp signal corresponding to the first analog gain,
wherein the first column line is connected to one analog-to-digital converter, and
wherein the second conversion gain is greater the first analog gain.

12. The method of claim 11, wherein
the performing of the first reset sampling operation includes applying a first offset to the first ramp signal,
the performing of the second reset sampling operation includes applying a second offset to the second ramp signal, and
a magnitude of the first offset is greater than a magnitude of the second offset.

13. The method of claim 12, wherein the magnitude of the first offset is greater than a voltage difference of the first reset level and the second reset level.

14. The method of claim 12, wherein the first ramp signal, the second ramp signal, the third ramp signal, and the fourth ramp signal changes based on a first voltage.

15. The method of claim 11, wherein, during a readout period in which the first reset sampling operation, the second reset sampling operation, the first signal sampling operation, and the second signal sampling operation are performed, the auto-zero operation is performed only once.

16. An image sensor comprising:
a first pixel configured to sequentially output a first pixel signal having a first reset level corresponding to a first conversion gain, a second pixel signal having a second reset level corresponding to a second conversion gain different from the first conversion gain, a third pixel signal having a second signal level corresponding to the second conversion gain, and a fourth pixel signal having a first signal level corresponding to the first conversion gain, the output through a first column line;
a ramp signal generator configured to sequentially output a first ramp signal corresponding to a first analog gain, a second ramp signal corresponding to a second analog gain smaller than the first analog gain, a third ramp signal corresponding to the second analog gain, and a fourth ramp signal corresponding to the first analog gain; and
an analog-to-digital converter connected to the first column line, and configured to perform an auto-zero operation based on the first reset level and to perform analog-to-digital conversion by comparing the first reset level and the first ramp signal, comparing the second reset level and the second ramp signal, comparing the second signal level and the third ramp signal, and comparing the first signal level and the fourth ramp signal, wherein
the first ramp signal and the fourth ramp signal correspond to a first offset,
the second ramp signal and the third ramp signal correspond to a second offset, and
the second offset has a negative value.

17. The image sensor of claim 16, wherein the analog-to-digital converter is further configured to:
perform the auto-zero operation only once while the analog-to-digital conversion is performed based on the first pixel signal, the second pixel signal, the third pixel signal, the fourth pixel signal, the first ramp signal, the second ramp signal, the third ramp signal, and the fourth ramp signal.

18. The image sensor of claim 16, wherein the image sensor is configured to determine a magnitude of the second offset based on a voltage difference of the first reset level the second reset level.

19. The image sensor of claim 16, wherein the first column line is connected to one analog-to-digital converter.

20. The image sensor of claim 16, wherein the first pixel includes:
a photelectric conversion element configured to accumulate charges in response to a light signal received from outside;
a transfer transistor connected between the photelectric conversion element and a floating diffusion node;
a reset transistor configured to provide a reset voltage to the floating diffusion node;
a dual conversion gain transistor connected between the floating diffusion node and the reset transistor;
a source follower transistor configured to generate a pixel signal corresponding to a voltage of the floating diffusion node; and
a selection transistor connected to the source follower transistor, and configured to output the pixel signal to the first column line, and
wherein, while the auto-zero operation is performed, the dual conversion gain transistor is turned on.
